(19) United States
(12) Patent Application Publication
(10) Pub. No.: US 2013/0275338 A1
(43) Pub. Date: Oct. 17, 2013

(54) INVESTMENT PLAN PLANNING APPARATUS, INVESTMENT PLAN PLANNING METHOD, AND INVESTMENT PLAN PLANNING PROGRAM

(71) Applicants: Junko Hosoda, Miura (JP); kenichi Funaki, Tokyo (JP)

(72) Inventors: Junko Hosoda, Miura (JP); kenichi Funaki, Tokyo (JP)

(21) Appl. No.: 13/883,120

(22) PCT Filed: Oct. 12, 2011
(86) PCT No.: PCT/JP2011/073370

§ 371 Date: Jun. 26, 2013

(30) Foreign Application Priority Data
Nov. 8, 2010 (JP) 2010-249990

(51) Int. Cl. G06Q 40/06

(52) U.S. Cl. CPC G06Q 40/06
USPC 705/36 R

(57) ABSTRACT

An investment plan planning apparatus being a computer apparatus that evaluates a fund in hand and an investment effect of the fund in hand to estimate an investment plan relating to product production, comprising an input unit that receives information from a user to store in a storage unit, the storage unit stores at least prediction information related to a period for debt collection from a customer, prediction information related to a period for debt payment to a supplier, actual sales information of a product, demand information predicted for the product, and actual purchase information of items and services required for product production, received by the input unit from a user, and a computing unit executing the processes of identifying a collection period of accounts receivable related to a predetermined product from the actual sales information of the product, demand information of the product, and a prediction information of the debt collection period related to a customer of the product, identifying a payment period of accounts payable generated at a time of production of the product from an actual purchase information and the demand information related to the product, and calculating a cash flow by subtracting an accounts payable payment amount from an accounts receivable collection amount of each period, comparing movement of the calculated cash flow for a case when the cash flow is not used for investment with an investment amount defined by a user through the input unit, identifying as an investable term a term when an amount of the cash flow exceeds the investment amount, calculating fund in hand and an investment effect when the fund in hand is invested in a user-specified investment target for the investable term, and identifying an investment period causing a maximum investment effect and an investment amount therefor, and displaying the cash flow movement and pieces of information of the investment effect on a display unit.

### TECHNICAL FIELD

The present invention relates to an investment plan planning apparatus, an investment plan planning method, and an investment plan planning program and specifically relates to a technique that allows to determine a suitable investment period and an investment amount by calculating fund in hand at the time of investment and evaluating the investment effect.

### BACKGROUND ART

Techniques of evaluating general investment effect include the ROI technique (return on investment: rate of return on invested capital). In the ROI method, cash flow is obtained by subtracting cost for maintaining an invested asset from income obtained from investment for the term from the investment to abandonment and multiplying a discount rate for converting to the current value and, if the sum of the current value of each period exceeds the amount to be invested, it is determined that the asset is worth investing.

However, in the ROI method, a technique of calculating income obtained from investment is not clarified. Therefore, for example, when making an investment in production facilities, it is not easy to calculate the income increased by the invested production facilities producing products.

With regard to such problem, Japanese Laid-Open Patent Publication No. 2006-31360 (Patent Document 1) presents a production line design support device for optimizing the production capacity and capital investment expenditure. This document describes that “a production line design support device for optimizing production capacity and capital investment expenditure in designing a production line is provided. the device comprises a production simulation part 11 for simulating a production line operation, based on production line plan information; and a countermeasure analyzing part 12 for selecting at least one facility with the production capacity and/or investment expenditure to be required in order to allow a simulation result to be close to target production ability and target investment expenditure from a countermeasure information storage part 15, and outputting it to the production simulation part. A simulation is repeated with the facility which is selected by the countermeasure analyzing part 12, so that the facility with the optimum production capacity and investment expenditure is automatically selected with respect to the plan of the production line.”

### CITATION LIST

### Patent Literature

[Patent Literature 1] Japanese Patent Application Laid-Open Publication No. 2006-31360

### SUMMARY OF THE INVENTION

### Problems to be Solved by the Invention

As described in above Patent Document 1, a mechanism of a production line design support device is proposed as a conventional technique. However, a conventional production line design support device requires input of target investment on the premise of real time investment and an investment period and the amount of investment cannot be determined appropriately. In the case of such production line design support device, for example, when demand after the time production line design recovers increasing the future fund in hand, and allowing the amount of investment to be increased, the production line design being performed with an amount of investment close to the target invested when designing the production line, necessary production capacity cannot be ensured in the future due to insufficient investment and cash flow will be reduced due to sales opportunities being lost.

Although the production line design support device of the conventional technique is evaluated by simulating an increase in production capacity when a production line is added, increase in cash flow through the addition of the production line is not calculated so that the investment effect cannot be evaluated.

It is therefore an object of the present invention to provide a technique capable of determining a suitable investment period and amount of investment by calculating the fund in hand at the time of investment and evaluating the investment effect.

### Means for Solving the Problems

An investment plan planning apparatus of the present invention for solving the above problems is a computer apparatus that evaluates a fund in hand and an investment effect of the fund in hand to estimate an investment plan relating to product production, including an input unit that receives information from a user to store in a storage unit; the storage unit stores at least prediction information related to a period for debt collection from a customer, prediction information related to a period for debt payment to a supplier, actual sales information of a product, demand information predicted for the product, and actual purchase information of items and services required for product production, received by the input unit from a user; and

a computing unit executing the processes of identifying a collection period of accounts receivable related to a predetermined product from the actual sales information of the product, demand information of the product, and a prediction information of the debt collection period related to a customer of the product, identifying a payment period of accounts payable generated at a time of production of the product from an actual purchase information and the demand information related to the product, and calculating a cash flow by subtracting an accounts payable payment amount from an accounts receivable collection amount of each period, comparing movement of the calculated cash flow for a case when the cash flow is not used for investment with an investment amount defined by a user through the input unit, identifying as an investable term a term when an amount of the cash flow exceeds the investment amount, calculating fund in hand and an investment effect when the fund in hand is invested in a user-specified investment target for the investable term, and identifying an investment period causing a maximum investment effect and an investment amount therefor, and displaying the cash flow movement and pieces of information of the investment effect on a display unit.

An investment plan planning method of the present invention has a computer apparatus including an input unit that receives information from a user to store in a storage unit, and the storage unit that stores at least prediction information related to a period for debt collection from a customer, prediction information related to a period for debt payment to a supplier, actual sales information of a product, demand information predicted for the product, and actual purchase information of items and services required for product production, received by the input unit from a user, to evaluate a fund in hand and an investment effect of the fund in hand, and the computer apparatus executes the processes of identifying a collection period of accounts receivable related to a predetermined product from the actual sales information of the product, demand information of the product, and a prediction information of the debt collection period related to a customer of the product, identifying a payment period of accounts payable generated at a time of production of the product from an actual purchase information and the demand information related to the product, and calculating a cash flow by subtracting an accounts payable payment amount from an accounts receivable collection amount of each period, comparing movement of the calculated cash flow for a case when the cash flow is not used for investment with an investment amount defined by a user through the input unit, identifying as an investable term a term when an amount of the cash flow exceeds the investment amount, calculating fund in hand and an investment effect when the fund in hand is invested in a user-specified investment target for the investable term, and identifying an investment period causing a maximum investment effect and an investment amount therefore, and displaying the cash flow movement and pieces of information of the investment effect on a display unit.

An investment plan planning program, causing a computer apparatus including an input unit that receives information from a user to store in a storage unit, and the storage unit that stores at least prediction information related to a period for debt collection from a customer, prediction information related to a period for debt payment to a supplier, actual sales information of a product, demand information predicted for the product, and actual purchase information of items and services required for product production, received by the input unit from a user, to evaluate a fund in hand and an investment effect of the fund in hand, to execute the steps of identifying a collection period of accounts receivable related to a predetermined product from the actual sales information of the product, demand information of the product, and a prediction information of the debt collection period related to a customer of the product, identifying a payment period of accounts payable generated at a time of production of the product from an actual purchase information and the demand information related to the product, and calculating a cash flow by subtracting an accounts payable payment amount from an accounts receivable collection amount of each period; comparing movement of the calculated cash flow for a case when the cash flow is not used for investment with an investment amount defined by a user through the input unit, identifying as an investable term a term when an amount of the cash flow exceeds the investment amount, calculating fund in hand and an investment effect when the fund in hand is invested in a user-specified investment target for the investable term, and identifying an investment period causing a maximum investment effect and an investment amount therefore, and displaying the cash flow movement and pieces of information of the investment effect on a display unit.

### Effect of the Invention

According to the present invention, a suitable timing and amount of investment can be determined by calculating fund in hand at the time of investment and evaluating the investment effect.

### BRIEF DESCRIPTION OF DRAWINGS

FIG. 1 is a block diagram of a functional configuration example of an investment plan planning apparatus of the first embodiment.

FIG. 2 is a block diagram of a hardware configuration example of the investment plan planning apparatus of the first embodiment.

FIG. 3 is a diagram of an example of a process executed by the investment plan planning apparatus of the first embodiment.

FIG. 4 is a diagram of an example of product configuration information.

FIG. 5 is a diagram of an example of supplier information.

FIG. 6 is a diagram of an example of customer information.

FIG. 7 is a diagram of an example of resources of production information.

FIG. 8 is a diagram of an example of supply rule information.

FIG. 9 is a diagram of an example of supply information.

FIG. 10 is a diagram of an example of unit purchase price information.

FIG. 11 is a diagram of an example of selling price information.

FIG. 12 is a diagram of an example of actual sales information.

FIG. 13 is a diagram of an example of actual purchase information.

FIG. 14 is a diagram of an example of investment planning condition information.

FIG. 15 is a diagram of process details of a parameter information reading process.

FIG. 16 is a diagram of an example of a parameter information input screen of the first embodiment.

FIG. 17 is a diagram of an example of an investment menu configuration screen of the first embodiment.

FIG. 18 is a diagram of an example of the investment menu configuration screen after user input according to the first embodiment.

FIG. 19 is a diagram of an example of a demand information configuration screen according to the first embodiment.

FIG. 20 is a diagram of an example of the demand information configuration screen after user input according to the first embodiment.

FIG. 21 is a diagram of an example of a currency exchange information configuration screen according to the first embodiment.

FIG. 22 is a diagram of an example of the currency exchange information configuration screen after user input according to the first embodiment.

FIG. 23 is a diagram of process details of a non-investment cash flow calculation process.

FIG. 24 is a diagram of an example of actual sales information stored in a storage unit after calculating a debt collection period of each record of the actual sales.

FIG. 25 is a diagram of an example of actual purchase information stored in the storage unit after calculating a debt payment period of each record of the actual purchase.

FIG. 26 is a diagram of an example of sales information of investable term.

FIG. 27 is a diagram of an example of sales information of investment collection evaluation term.

FIG. 28 is a diagram of an example of purchase information of investable term.

FIG. 29 is a diagram of an example of purchase information of investment collection evaluation term.

FIG. 30 is a diagram of an example of expenditure information of the investable term.

FIG. 31 is a diagram of an example of expenditure information of the investment collection evaluation period.

FIG. 32 is a diagram of process details of production simulation.

FIG. 33 is a diagram of an example of cash flow movement information of the investable term.

FIG. 34 is a diagram of an example of cash flow movement information of the investment collection evaluation term.

FIG. 35 is a diagram of process details of an investment period and cash flow calculation process.

FIG. 36 is a diagram of an example of investment information.

FIG. 37 is a diagram of process details of an investment period and cash flow movement calculation process.

FIG. 38 is a diagram of an example of investment information stored in the storage unit after executing the investment period and cash flow calculation process.

FIG. 39 is a diagram of an example of an investment period result screen according to the first embodiment.

FIG. 40 is a diagram of an example of a cash flow movement result screen according to the first embodiment.

FIG. 41 is a diagram of an example of a process executed by an investment plan planning apparatus of a second embodiment.

FIG. 42 is a diagram of an example of actual financing information.

FIG. 43 is a diagram of an example of a parameter information input screen of the second embodiment.

FIG. 44 is a diagram of an example of a financing information configuration screen of the second embodiment.

FIG. 45 is a diagram of an example of the financing information configuration screen after user input according to the second embodiment.

FIG. 46 is a diagram of process details of the investment period and investment effect calculating process according to the second embodiment.

FIG. 47 is a diagram of an example of financing planning information of the second embodiment.

FIG. 48 is a diagram of an example of a process executed by an investment plan planning apparatus of the third embodiment.

FIG. 49 is a diagram of an example of initial fund in hand information.

FIG. 50 is a diagram of an example of an investment menu configuration screen according to the third embodiment.

FIG. 51 is a diagram of an example of process details of a non-investment cash flow calculation process.

FIG. 52 is a diagram of an example of investable period cash flow movement information by capital.

FIG. 53 is a diagram of an example of a calculation result screen of the cash flow movement by capital according to the third embodiment.

### MODES FOR CARRYING OUT THE INVENTION

### First Embodiment

In this embodiment, description will be made of an example of an investment plan planning apparatus evaluating fund in hand and investment effect at each future time point to calculate a suitable investment plan. Although investment in production facilities and investment for increasing sales force in the manufacturing industry will be described as examples of investment in this embodiment, other investments can be handled in the same way. The concept of the investment for increasing sales force also includes investments related to employment of human resources assigned to business activities, advertisement of products, and execution of marketing. The concept of the investment in production facilities also includes investment to a parts vendor providing parts that make up a product or investment to subcontracting processors contracting for various processing operations at the time of manufacturing of the product.

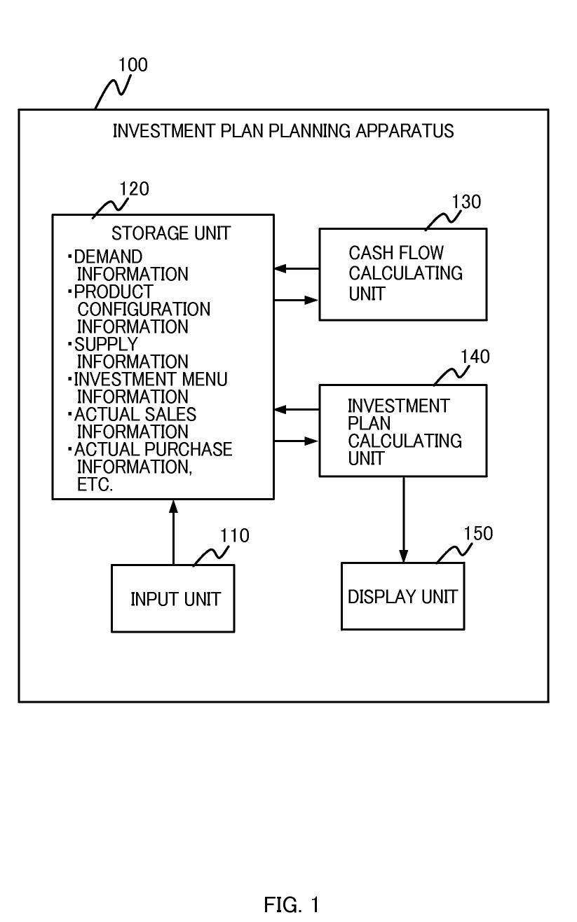

FIG. 1 is a block diagram of a functional configuration example of an investment plan planning apparatus 100 of this embodiment. The investment plan planning apparatus 100 has an input unit 110, a storage unit 120, a cash flow calculating unit 130, an investment plan calculating unit 140, and a display unit 150.

The input unit 110 is a user interface for receiving input operation from a user. The storage unit 120 stores product configuration information, supplier information, customer information, production resource information, supply rule information, supply information, unit purchase price information, selling price information, investment information, actual sales information, actual purchase information, investment planning condition information, demand information, investment menu information, financing information, and currency exchange information received from outside by the input unit 110. The storage unit 120 stores cash flow movement information calculated by the cash flow calculating unit 130 and investment information calculated by the investment plan calculating unit 140.

The cash flow calculating unit 130 reads the information stored in the storage unit 120, calculates cash flow, and stores the calculated result into the storage unit 120. The investment plan calculating unit 140 reads the information stored in the storage unit 120, receives the cash flow movement information calculated by the cash flow calculating unit 130, and calculates an investment period and investment effect for each record of the investment information. The display unit 150 is a user interface for displaying various operation screens and images on a display in accordance with instructions from another functional unit.

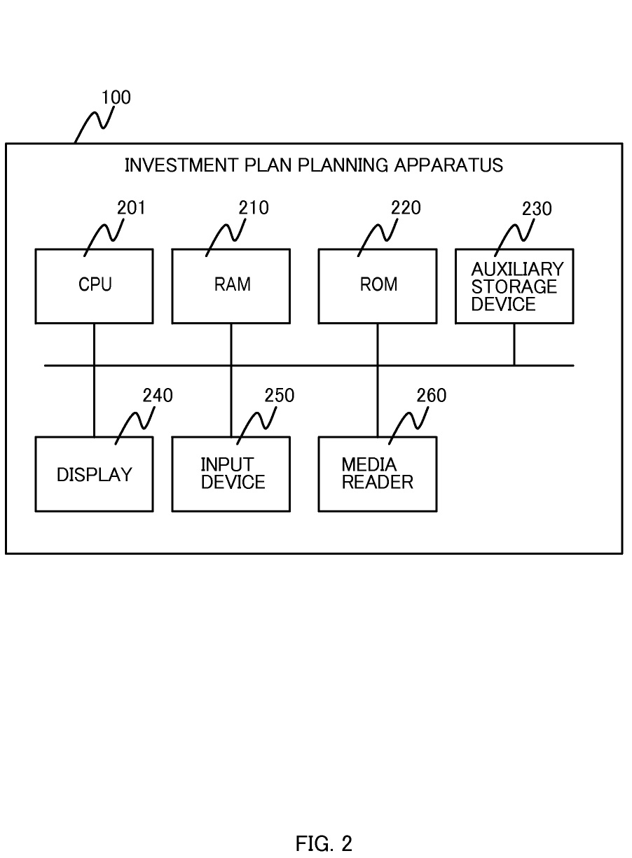

FIG. 2 is a block diagram of a hardware configuration example of the investment plan planning apparatus 100 of this embodiment. The investment plan planning apparatus 100 has a CPU 201 corresponding to a computing unit, a RAM 210, a ROM 220, an auxiliary storage device 230, a display 240, an input device 250, and a media reader 260.

The CPU 201 is a unit that executes various calculations. The CPU 201 performs various processes by executing a predetermined investment plan planning apparatus program (not depicted) loaded from the auxiliary storage device 230 to the RAM 210.

The investment plan planning apparatus program is an application program executable on an OS (operating system) program, for example. The investment plan planning apparatus program may be installed from a portable storage medium via the media reader 260 into the auxiliary storage device 230, for example.

The RAM 210 is a memory storing a program executed by the CPU 201 and data necessary for executing the program. The ROM 220 is a memory for storing a program necessary for activating the investment plan planning apparatus 100.

The auxiliary storage device 230 may be, for example, a device such as an HDD (hard disk drive) or an SSD (solid state drive) using a flash memory and the like.

The display 240 is a device such as a CRT display, an LCD (liquid crystal display), and an organic EL (electro-luminescence) display, for example. The input device 250 is a device such as a keyboard, a mouse, and a microphone, for example. The media reader 260 is a device that reads information of a portable storage medium being portable such as CD-ROM.

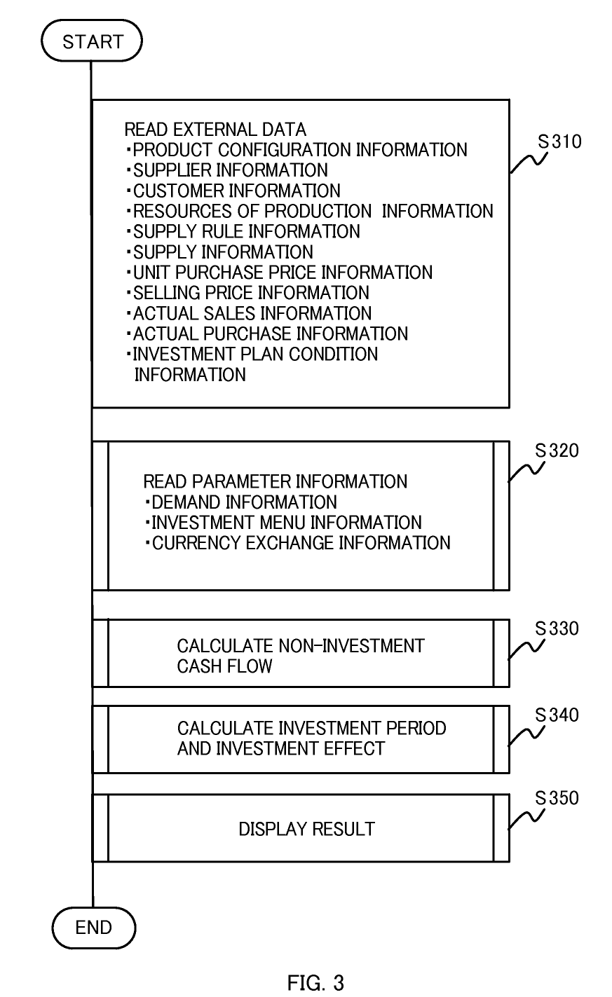

FIG. 3 is a diagram of a process flow example of an investment plan planning method executed by the investment plan planning apparatus 100. The investment plan planning apparatus 100 executes an external data reading process 5310, a parameter information reading process S320, a non-investment cash flow calculation process 5330, and an investment period and cash flow calculation process 5340, and result displaying process S350.

In the external data reading process 5310, the input unit 110 reads (receives as input from a user) and stores into the storage unit 210 the product configuration information, the supplier information, the customer information, the resources of production information, the supply rule information, the supply information, the unit purchase price information, the selling price information, the actual sales information, the actual purchase information, and the investment plan condition information stored in text format, for example.

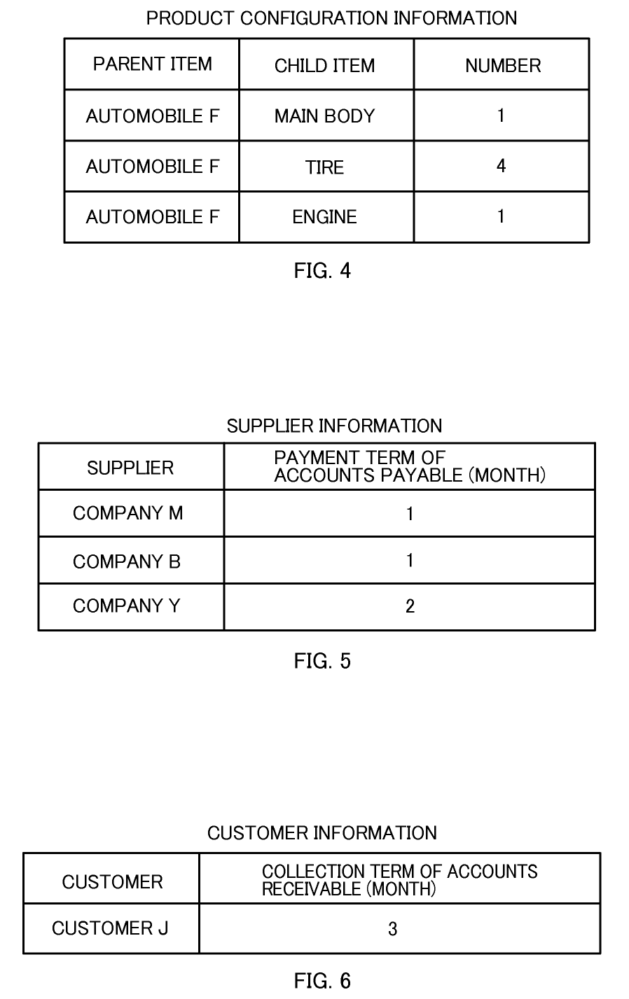

The above pieces of information stored in the storage unit 120 will be described. FIG. 4 depicts an example of product configuration information. The product configuration information has information defined as child items configuring a parent item. A parent item column has described therein a product name; a child item column has described therein a name of item configuring a parent item of the corresponding record; and a number column has described therein the number of child items required for producing one parent product of the corresponding record.

FIG. 5 depicts an example of supplier information. The supplier information has information defined therein outside trading partners generating accounts payable. In the supplier information, the supplier column has described a supplier name and the payment term of accounts payable (month) column has described therein the term from purchase of material to payment for the purchase when the material is purchased from the supplier of the corresponding record.

FIG. 6 depicts an example of customer information. The customer information has information defined therein outside trading partners generating accounts receivable. In the customer information, the customer column describes the customer name and the accounts debt collection term (month) column has described therein the term from sales of a product until collection of debt when the product is sold to the customer of the corresponding record.

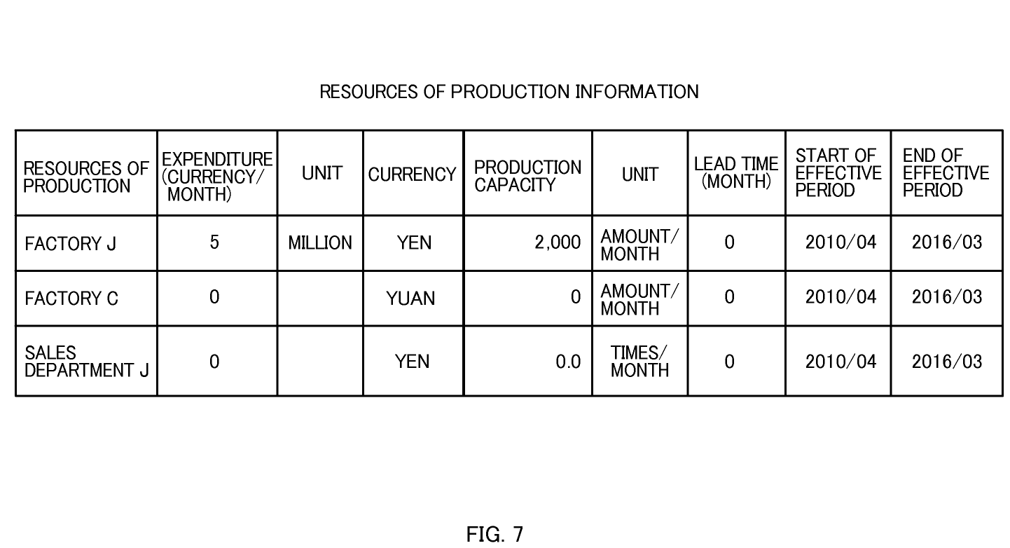

FIG. 7 depicts an example of resources of productions information. The resources of production information have described therein information of resources retained in-house and supplied for production by a product manufacturer. It is assumed that the resources of production of this embodiment are “factories” conducting actual production and “sales departments” conducting product sales activities. In the resources of production information, the resources of production column has described therein the name of resources of production; the expenditure (currency/month) column has described therein the expenditure per month for the resources of production of the corresponding record; the currency column has described therein the currency of the expenditure; the production capacity column has described therein the capacity increased by the resources of production of the corresponding record; the unit column has described therein the unit of the production capacity; the lead time (month) column has described therein the lead time required for making a product with the resources of production of the corresponding record; the start of effective period column has described therein the start period of the effective term of the corresponding record; and the end of effective period column has described therein the end period of the effective term of the corresponding record.

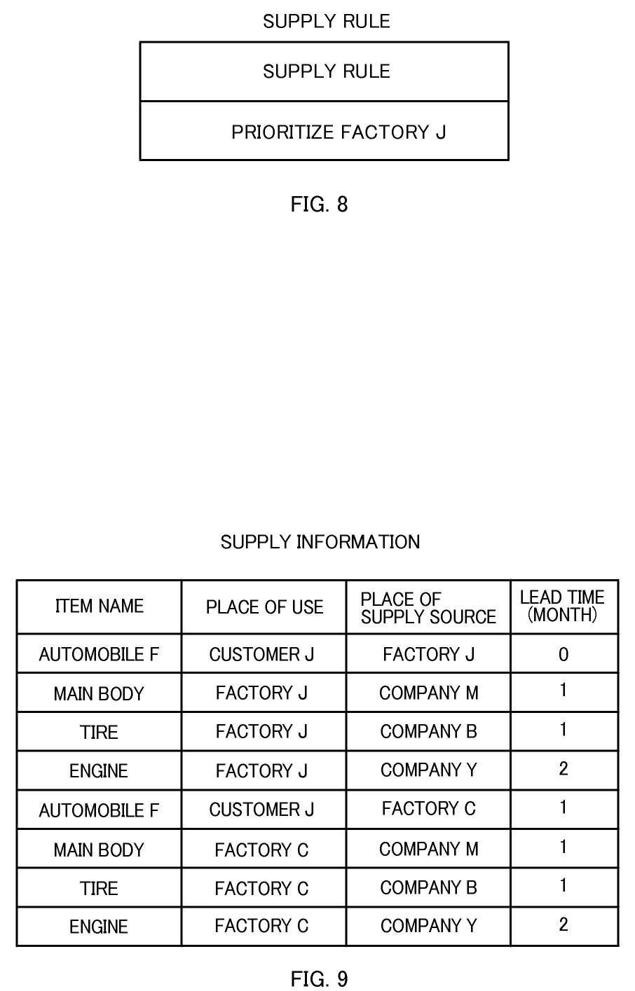

FIG. 8 depicts an example of supply rule information. In the supply rule information, the supply rule column has described therein the supply rule character string complying with a predetermined description rule. In this example, the supply rule information includes a factory specified by the factory name and “prioritize” indicative of a rule that when a spare production capacity exists, the production capacity of the corresponding factory is preferentially used.

FIG. 9 depicts an example of supply information. In the supply information, the item name column has described therein the item name; the place-of-use column has described therein the name of place where then item of the corresponding record is used; the place of supply source column has described therein the name of place supplying the item of the corresponding record; and the lead time (month) column has described therein the lead time required for supplying the item of the corresponding record from the place of supply source to the place of use.

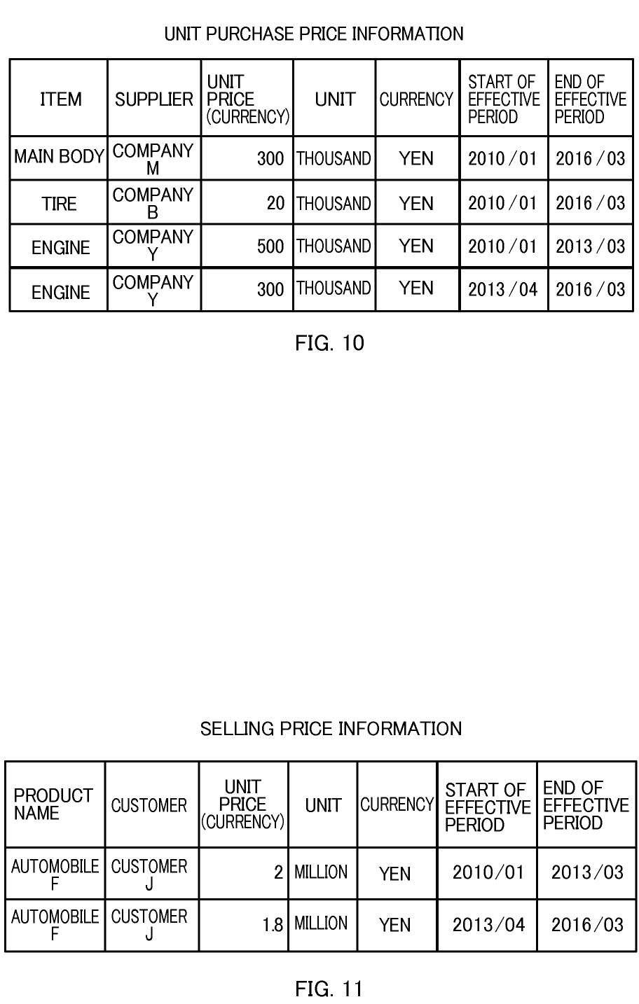

FIG. 10 depicts an example of the unit purchase price information. In the unit purchase price information, the item column has described therein the item name; the supplier column has described therein the name of the supplier supplying the item of the corresponding record; the unit price (currency) column has described therein the unit price when the item of the corresponding record is purchased from the supplier of the corresponding record; the unit column has described therein the unit of the price; the currency column has described therein the currency; the start of effective period column has described therein the start period of the term during which the corresponding record is effective; and the end of effective period column has described therein the end period of the term during which the corresponding record is effective.

FIG. 11 depicts an example of selling price information. In the selling price information, the product name column has described therein the product name; the customer column has described therein the name of the customer to which the product of the corresponding record is sold; the unit price (currency) column has described therein the unit price when the product of the corresponding record is sold to the customer of the corresponding record; the unit column has described therein the unit of the price; the currency column has described therein the currency; the start of effective period column has described therein the start period of the term during which the corresponding record is effective; and the end of effective period column has described therein the end period of the term during which the corresponding record is effective.

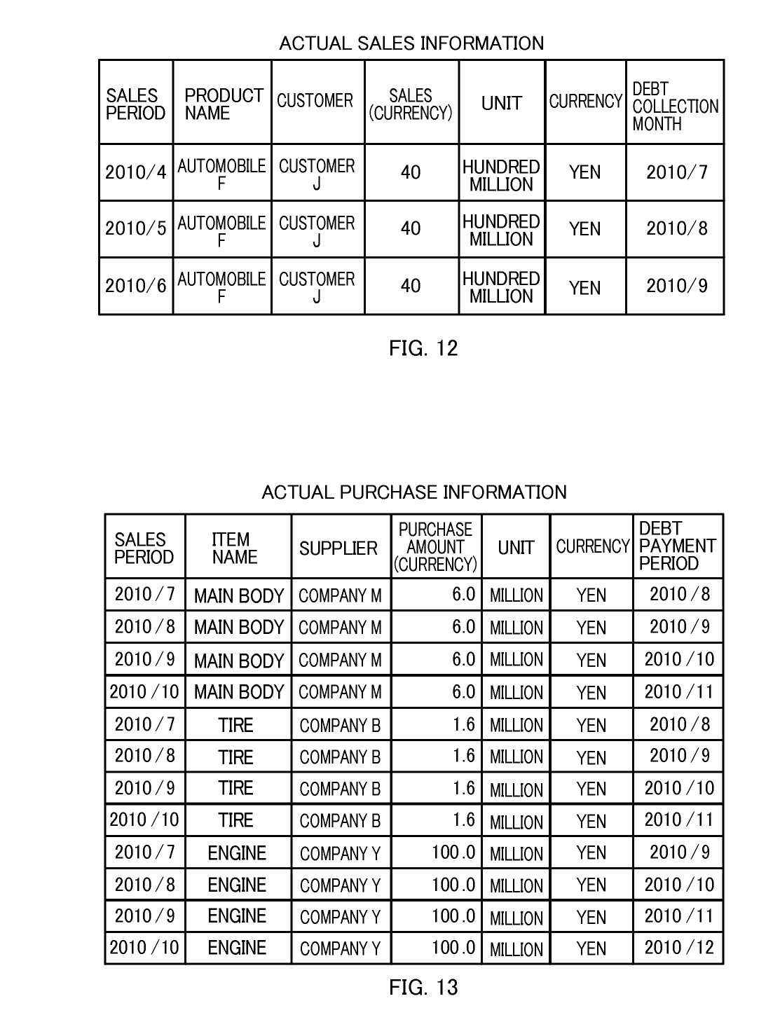

FIG. 12 depicts an example of the actual sales information. In the actual sales information, the sales period column describes the period when the product is sold; the product name column has described therein the name of the product sold; the customer column has described therein the name of the customer being the sale destination; the sales (currency) column has described therein the monetary amount of the product of the corresponding record sold to the customer of the corresponding record during the period of the corresponding record; the unit column has described therein the unit of the price; and the currency column describes the currency.

FIG. 13 depicts an example of the actual purchase information. In the actual purchase information, the purchase period column has described therein the period when an item was purchased; the item name column has described therein the name of purchased item; the supplier column has described therein the name of the supplier from which the item was purchased; the purchase amount (currency) column has described therein the monetary amount of the purchased item of the corresponding record purchased from the supplier of the corresponding record during the period of the corresponding record; the unit column has described therein the unit of the price; and the currency column has described therein the currency.

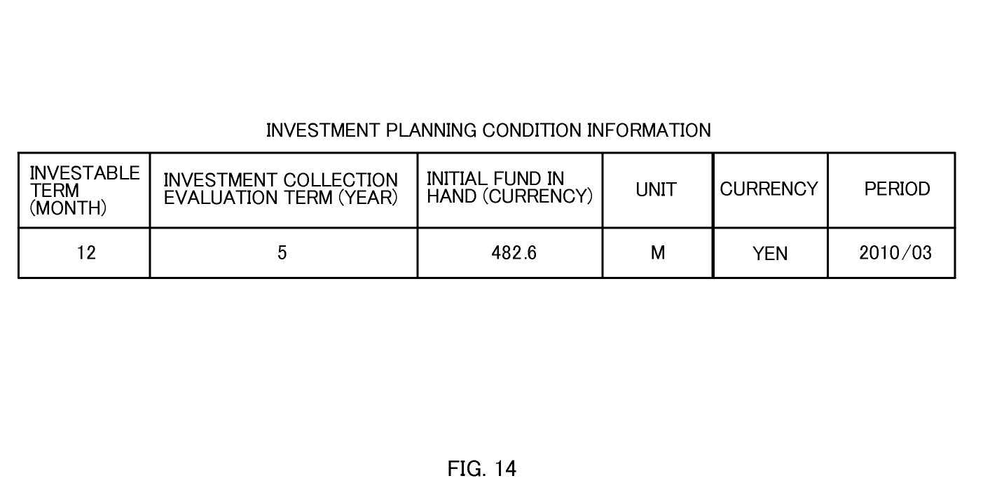

FIG. 14 depicts an example of the investment planning condition information. The investment planning condition information has described therein the precondition of investment planning. In this example, the investment start evaluation term (month) column has described therein the term during which investment can be performed; the investment collection evaluation term (year) column has described therein the term during which the investment collection status is evaluated; the initial fund in hand (currency) column has described therein the amount of initial fund in hand; the unit column has described therein the unit of the initial fund in hand; the currency column has described therein the currency of the initial fund in hand; and the period column has described therein the initial period.

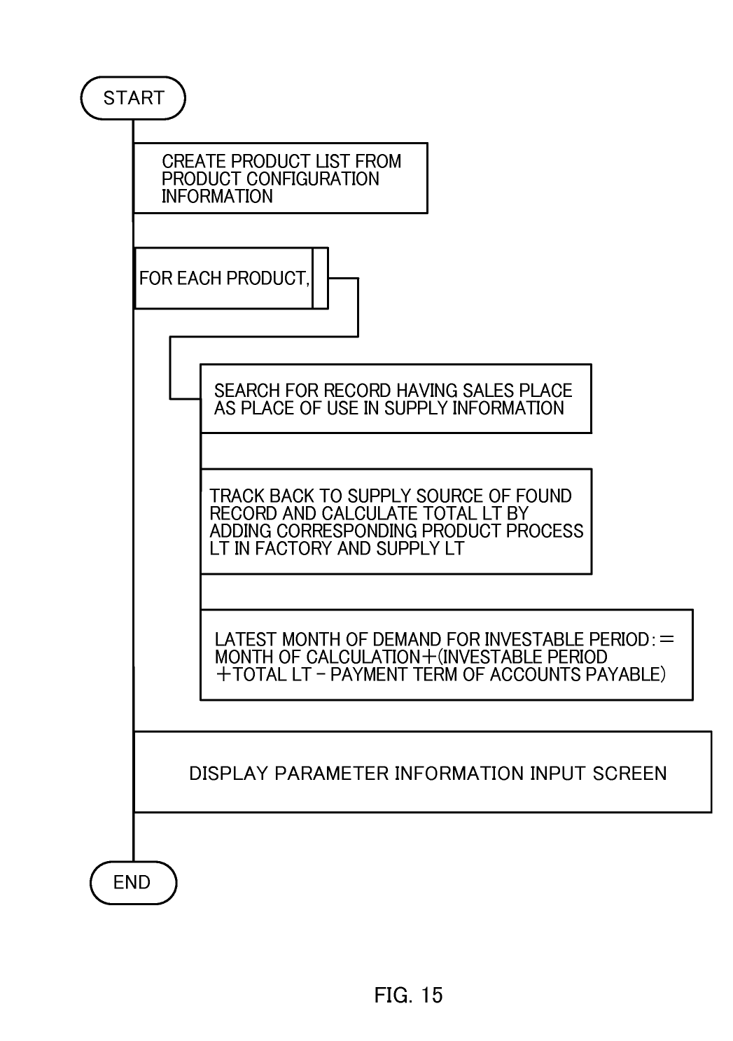

FIG. 15 depicts process details of a parameter information reading process S320 executed by the cash flow calculating unit 130. The cash flow calculating unit 130 creates a product list from the product configuration information and executes the following processes for each product in the list. Specifically, the cash flow calculating unit 130 executes the processes of searching for a record having the sales place as the place of use in the supply information, tracking back to the supply source of the record found by the search, calculating a total lead time by adding a corresponding product process lead time and a supply lead time in a factory, and calculating the latest month of demand in the investable period from the formula of; month of calculation+(investable period+total lead time−payment period of accounts payable). The cash flow calculating unit 130 subsequently displays a parameter information input screen described later.

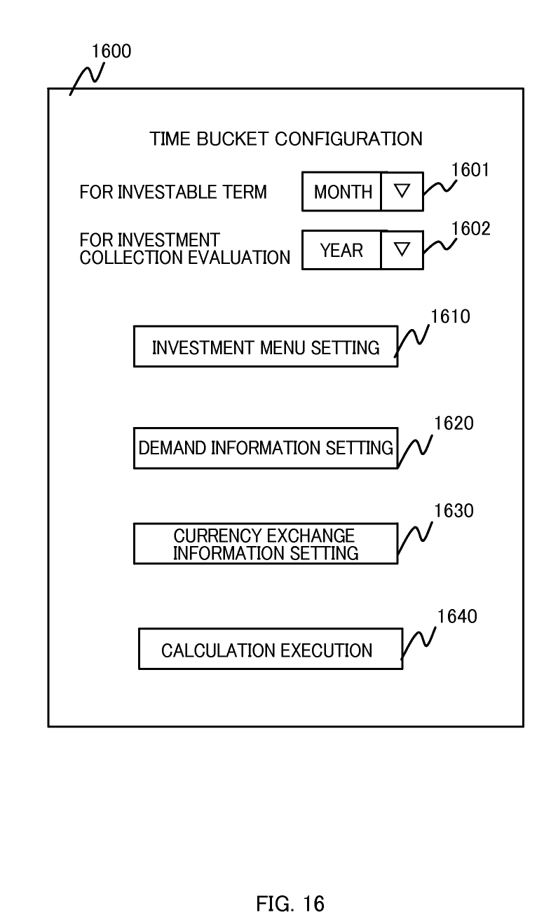

FIG. 16 depicts an example of the parameter information input screen. This parameter information input screen 1600 has an investable term bucket selection box 1601, an investment collection evaluation time bucket selection box 1602, an investment menu setting icon 1610, a demand information setting icon 1620, a currency exchange information setting icon 1630, and a calculation execution icon 1640.

The investable term bucket selection box 1601 receives input from a user through the input device 250. The display unit 150 preliminarily assigns choices of the investable term time bucket selection box 1910 and a user selects anyone of the choices. When a user selects a choice of the investable term bucket selection box 1601, the display unit 150 reassigns time buckets equal to or greater than the selected time bucket as choices of the investment collection evaluation time bucket selection box 1602.

The investment collection evaluation time bucket selection box 1602 receives input from a user through the input device 250.

The investment menu setting icon 1610 receives input from a user through the input device 250. When the user selects the investment menu setting icon 1610, the display unit 150 displays an investment menu configuration screen 1700.

The demand information setting icon 1620 receives input from a user through the input device 250. When the user selects the demand information setting icon 1620, the display unit 150 inputs a sales period, a product name, and a customer of an investable term demand setting data grid 1910 in accordance with the time bucket selected in the investable term bucket selection box 1601. The display unit 150 inputs a sales period, a product name, and a customer of an investment collection evaluation demand setting data grid 1920 in accordance with the time bucket selected in the investment collection evaluation time bucket selection box 1602 to display a demand information configuration screen 1900.

The currency exchange information setting icon 1630 receives input from a user through the input device 250. When a user selects the currency exchange information setting icon 1630, the display unit 150 inputs a period and a currency of an investable term currency exchange setting data grid 2110 in accordance with the time bucket selected in the investable term bucket selection box 1601. The display unit 150 inputs a period and a currency of an investment collection evaluation currency exchange setting data grid 2120 in accordance with the time bucket selected in the investment collection evaluation time bucket selection box 1602 to display a currency exchange information setting screen 2100.

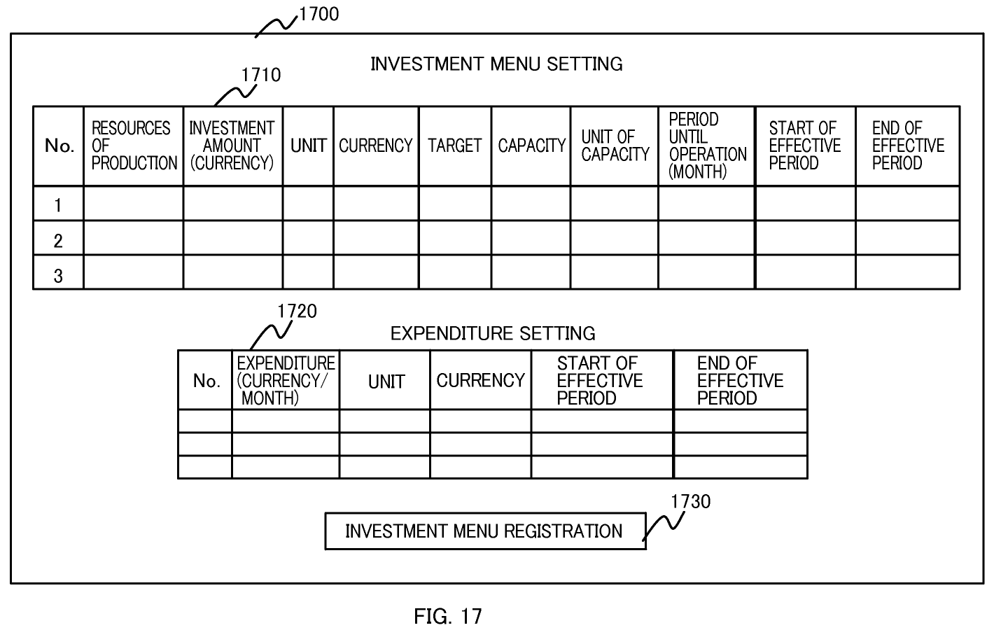

FIG. 17 depicts an example of the investment menu configuration screen. The investment menu configuration screen 1700 has an investment menu setting data grid 1710, an investment menu expenditure setting data grid 1720, and an investment menu registration icon 1730.

The investment menu setting data grid 1710 receives input from a user through the input device 250. The user inputs through the input device 250 the name of resources of production in which an investment is made into the resources of production column, an investment amount into an investment amount (currency) column, the unit of the investment amount into the unit column, the currency of the investment amount into the currency column, an target to be increased in capacity into the target column, the quantity of capacity to be increased by an investment of the corresponding record into the capacity column, the unit of capacity into the capacity unit column, the period from making the investment of the corresponding record until operation of facilities into a period until operation (month) column, the start period of the effective term of the corresponding record into the start of effective period column, and the end period of the effective term of the corresponding record into the end of effective period column. The setting of the investment menu may be performed with not only the method of allowing input to the data grid 1710 but also a method such as reading a text file in which the investment menu is input.

The investment menu cost setting data grid 1720 receives input from a user through the input device 250. The user inputs through the input device 250 an investment menu number into the number column, expenditure per month for resources of production of the corresponding investment menu number into the expenditure (currency/month), the unit of expenditure into the unit column, the currency of expenditure into the currency column, the start period of the effective term of the corresponding record into the start of effective period column, and the end period of the effective term of the corresponding record into the end of effective period column. The expenditure setting of the investment menu may be performed with not only a method of allowing input to the data grid 1720 but also a method such as reading a text file in which the expenditure of the investment menu is entered.

The investment menu registration icon 1730 receives input from a user through the input device 250. When the user selects the investment menu registration icon 1730, the input unit 110 reads the information input to the investment menu setting data grid 1710 and the investment menu expenditure setting data grid 1720 and stores the information into the storage unit 120. The display unit 150 displays the parameter information input screen 1600.

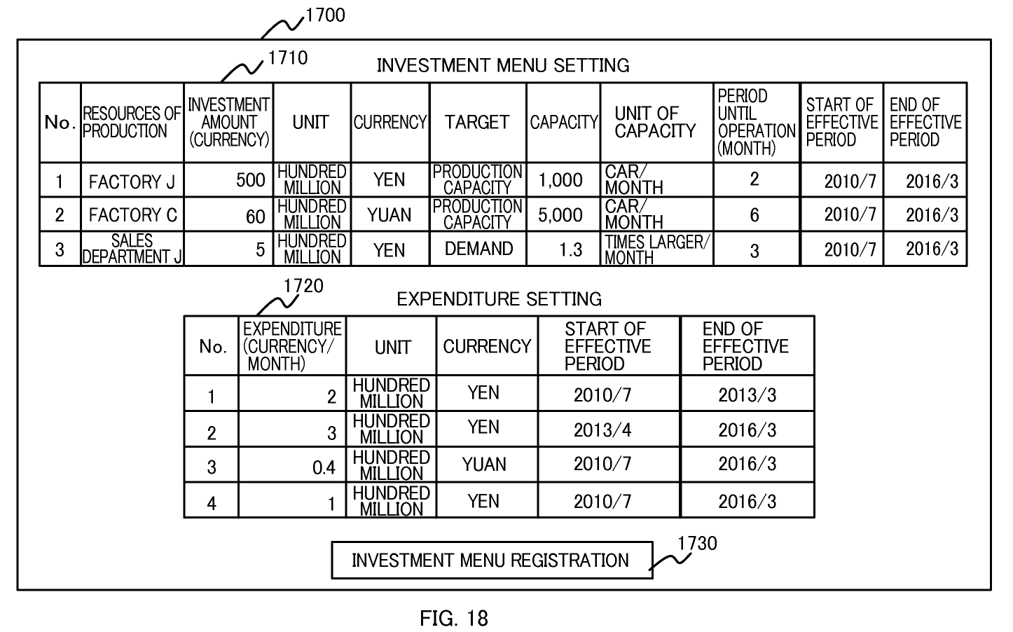

FIG. 18 depicts an example of the investment menu configuration screen 1700 after a user inputs data through the input device 250 to the investment menu setting data grid 1710 and the investment menu expenditure setting data grid 1720.

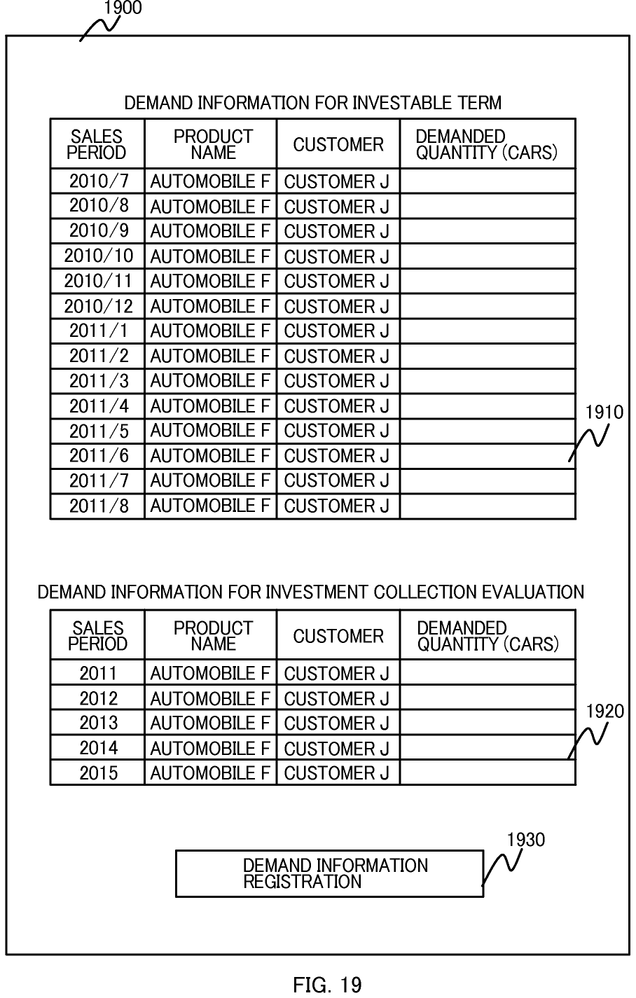

FIG. 19 depicts an example of a demand information configuration screen. The demand information configuration screen 1900 has an investable term demand setting data grid 1910, an investment collection evaluation demand setting data grid 1920, and a demand information registration icon 1930.

The investable term demand setting data grid 1910 receives input from a user through the input device 250. The user inputs the demanded quantity of the corresponding record into the column of demanded quantity (cars) through the input device 250.

The investment collection evaluation demand setting data grid 1920 receives input from a user through the input device 250. The user inputs the demanded quantity o of the corresponding record into the column of demanded quantity (cars) through the input device 250.

The demand information registration icon 1930 receives input from the user through the input device 250. When the user selects the demand information registration icon 1930, the input unit 110 reads the information input to the investable term demand setting data grid 1910 and the investment collection evaluation demand setting data grid 1920 and stores the information into the storage unit 120. The display unit 150 displays the parameter information input screen 1600. The setup of the demand information may be performed with not only a method of allowing input to the data grids 1910, 1920 but also a method such as reading a text file in which the demand information is entered.

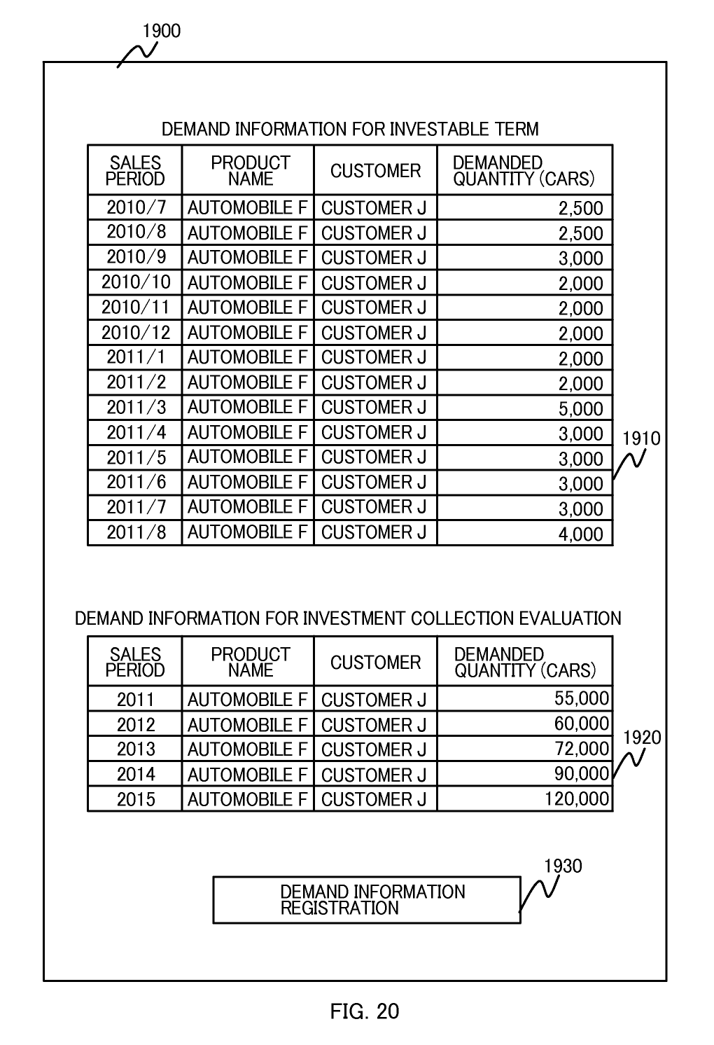

FIG. 20 depicts an example of the demand information configuration screen 1900 after a user inputs data through the input device 250 into the investable term demand setting data grid 1910 and the investment collection evaluation demand setting data grid 1920.

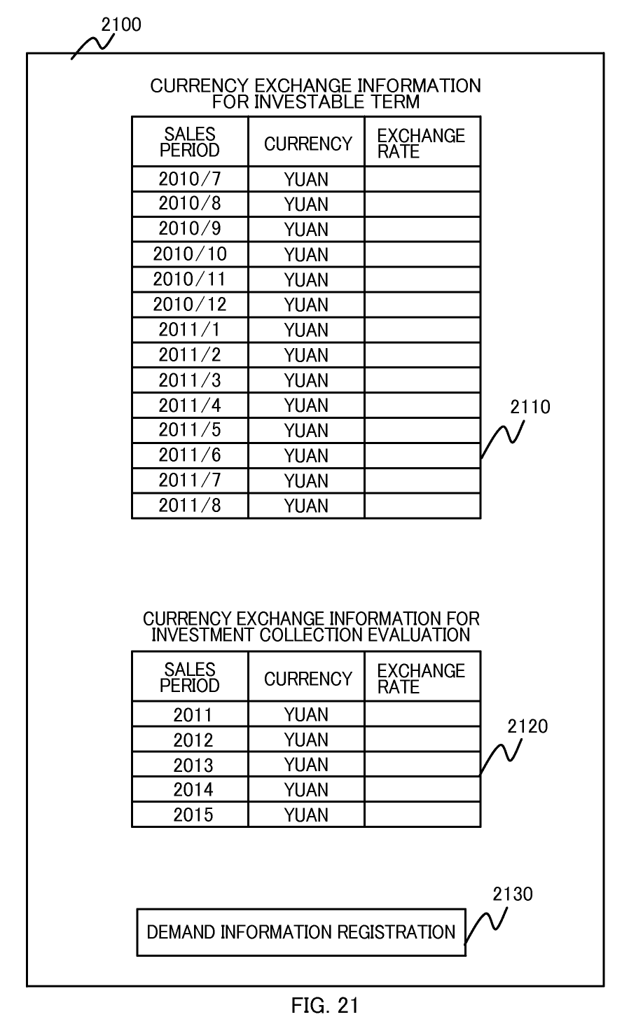

FIG. 21 depicts an example of a currency exchange information configuration screen. The currency exchange information configuration screen 2100 has the investable term currency exchange setting data grid 2110, the investment collection evaluation currency exchange setting data grid 2120, and a currency exchange information registration icon 2130.

The investable term currency exchange setting data grid 2110 receives input from a user through the input device 250. The user inputs an exchange rate of the corresponding record into the exchange rate column through the input device 250.

The investment collection evaluation currency exchange setting data grid 2120 receives input from a user through the input device 250. The user inputs an exchange rate of the corresponding record into the exchange rate column through the input device 250.

The currency exchange information registration icon 2130 receives input from the user through the input device 250. When the user selects the currency exchange information registration icon 2130, the input unit 110 reads the information input to the investable term currency exchange setting data grid 2110 and the investment collection evaluation currency exchange setting data grid 2120 and stores the information into the storage unit 120. The display unit 150 displays the parameter information input screen 1600. The setting of the currency exchange information may be performed with not only a method of allowing input to the data grids 2110, 2120 but also a method such as reading a text file in which the currency exchange information is entered.

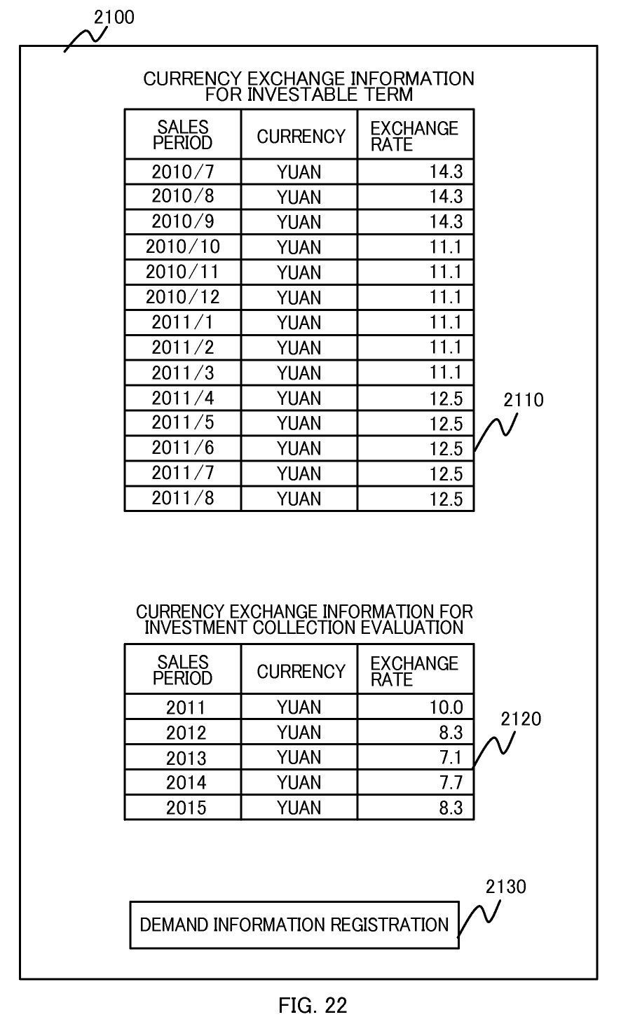

FIG. 22 depicts an example of the currency exchange configuration screen 2100 after a user inputs data through the input device 250 to the investable term currency exchange setting data grid 2110 and the investment collection evaluation currency exchange s setting data grid 2120.

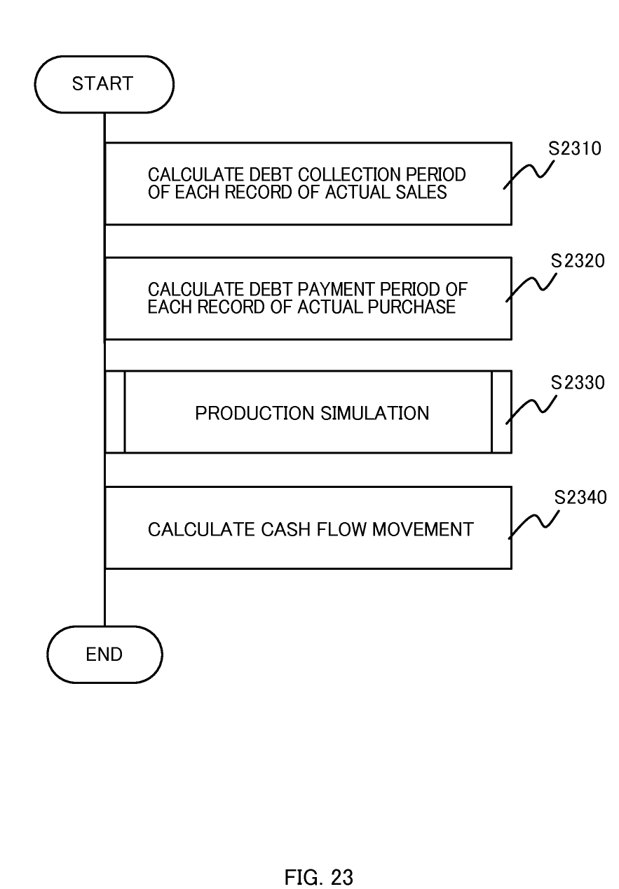

FIG. 23 depicts process details of the non-investment cash flow calculation process 5330 executed by the cash flow calculating unit 130. In this case, in the process of calculating the debt collection period of each record of the actual sales S2310, the cash flow calculating unit 130 calculates the debt collection period for each record of the actual sales information stored in the storage unit 120 in accordance with the following Equation (1).

debt collection period for each record of actual sales=sales period of the record of the actual sales+period until collection of accounts receivable of a record having identical place of sales in the customer information Eq. 1

In the process of calculating a debt payment period of each record of an actual purchase S2320, the cash flow calculating unit 130 calculates the debt payment period for each record of the actual purchase information stored in the storage unit 120 in accordance with the following Equation (2).

debt payment period for each record of an actual sales=purchase month of the record of the actual purchase+period until payment of accounts payable of the record having an identical supplier in the supplier information Eq. 2

In the production simulation process S2330, the cash flow calculating unit 130 performs a production simulation by using an existing program etc., based on the demand information and the resources of production information to calculate a purchase amount and a debt payment period of each supplier, expenditure of each resources of production, and a sales amount and a debt collection period of each customer, for each investable period time bucket and each investment collection evaluation time bucket stored in the storage unit 120.

In the cash flow movement calculation process S2340, the cash flow calculating unit 130 calculates cash flow for each investable period time bucket and each investment collection evaluation time bucket stored in the storage unit 120 in accordance with the following Equation (3). Although a multiplication by an exchange rate of a corresponding bucket is performed in each term of Equation (3), the exchange rate of the sales period may be multiplied in the case of the actual sales result information and the sales information and the exchange rate of the purchase period may be multiplied in the case of the actual purchase and the purchase information.

$$cash flow of each time bucket = sales amount of a record having an identical debt collection period in the actual sales information \times the exchange rate of the time bucket + sales amount of a record having an identical debt collection period in sales information \times the exchange rate of the time bucket - expenditure of the resources of production \times the exchange rate of the time bucket - purchase amount of a record having an identical debt payment period in the actual purchase \times the exchange rate of the time bucket - purchase amount of a record having an identical debt payment period in the purchase information \times the exchange rate of the time bucket \qquad Eq . 3$$

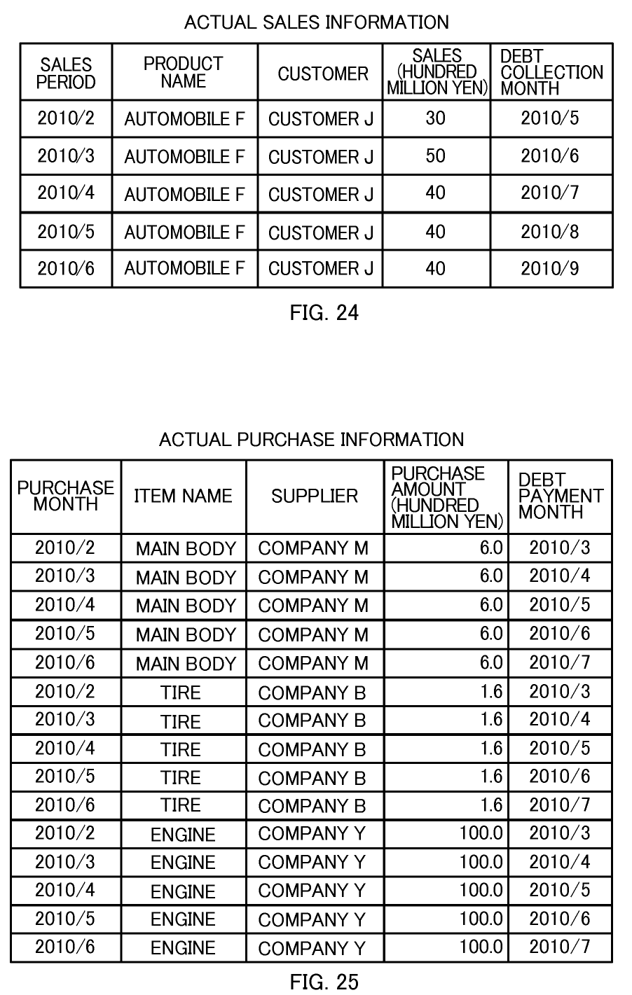

FIG. 24 depicts an example of the actual sales information stored in the storage unit 120 after the cash flow calculating unit 130 calculates a debt collection period of each record of the actual sales.

FIG. 25 depicts an example of the actual purchase information stored in the storage unit 120 after the cash flow calculating unit 130 calculates a debt payment period of each record of the actual purchase.

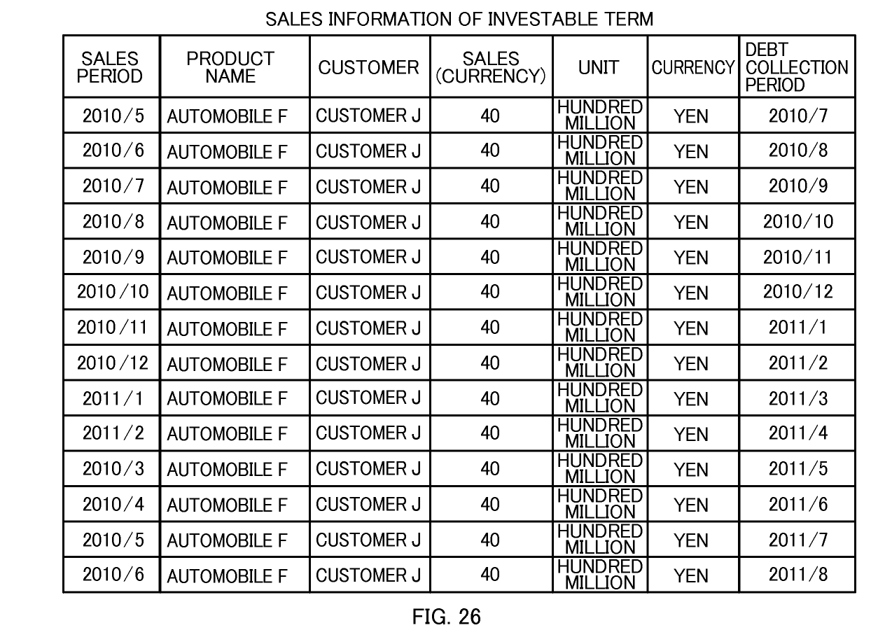

FIG. 26 depicts an example of the sales information of the investable term calculated by the cash flow calculating unit 130 in the production simulation process S2330. In this sales information, the sales period column describes the period of sale; the product name column describes the name of the product sold; the customer column describes the name of the customer being the sales destination; the sales (currency) column describes the sales amount of the corresponding record; the unit column describes the unit of the sales amount; the currency column describes the currency of the sales amount; and the debt collection period describes the period when the trade receivables are collected.

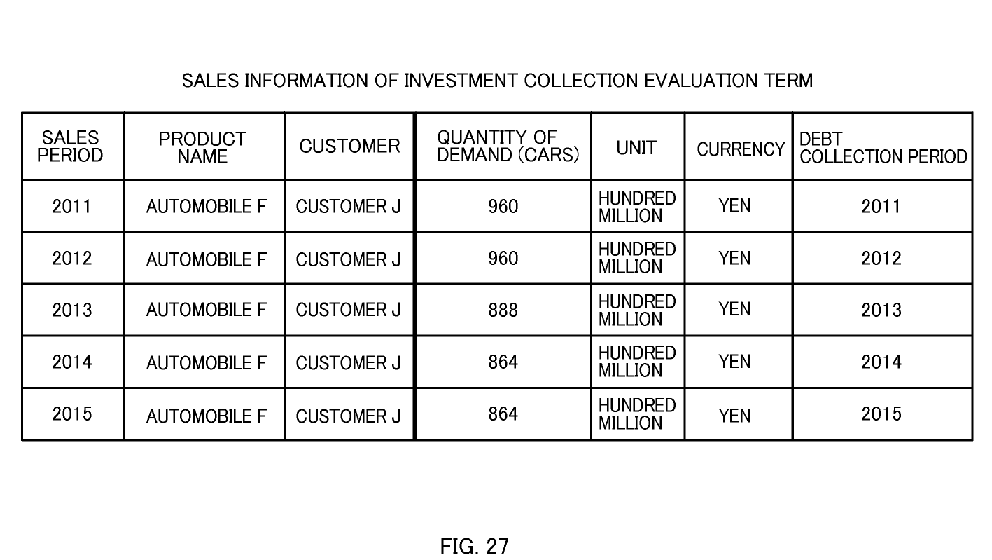

FIG. 27 depicts an example of the sales information of the investment collection evaluation term calculated by the cash flow calculating unit 130 in the production simulation process S2330. In this sales information, the sales period column describes the period of sale; the product name column describes the name of the product sold; the customer column describes the name of the customer being the sales destination; the sales (currency) column describes the sales amount of the corresponding record; the unit column describes the unit of the sales amount; the currency column describes the currency of the sales amount; and the debt collection period describes the period when the accounts receivable is collected.

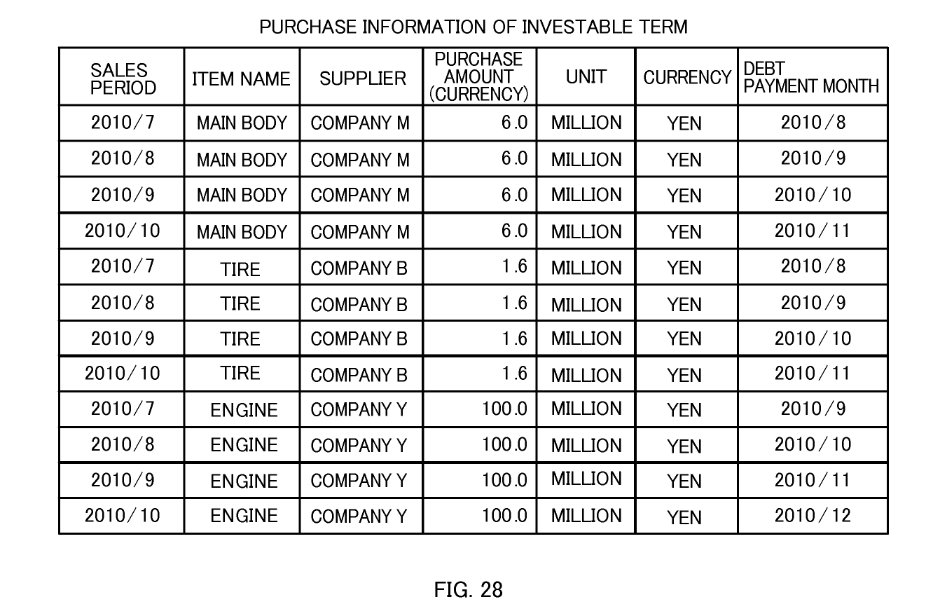

FIG. 28 depicts an example of the purchase information of the investable term calculated by the cash flow calculating unit 130 in the production simulation process S2330. In this purchase information, the purchase period column describes the period of purchase; the item name column describes the name of the purchased product; the supplier column describes the name of supplier from which the product is purchased; the purchase amount (currency) column describes the purchase amount of the corresponding record; the unit column describes the unit of the sales amount; the currency column describes the currency of the sales amount; and the debt payment period describes the period when the accounts payable is paid.

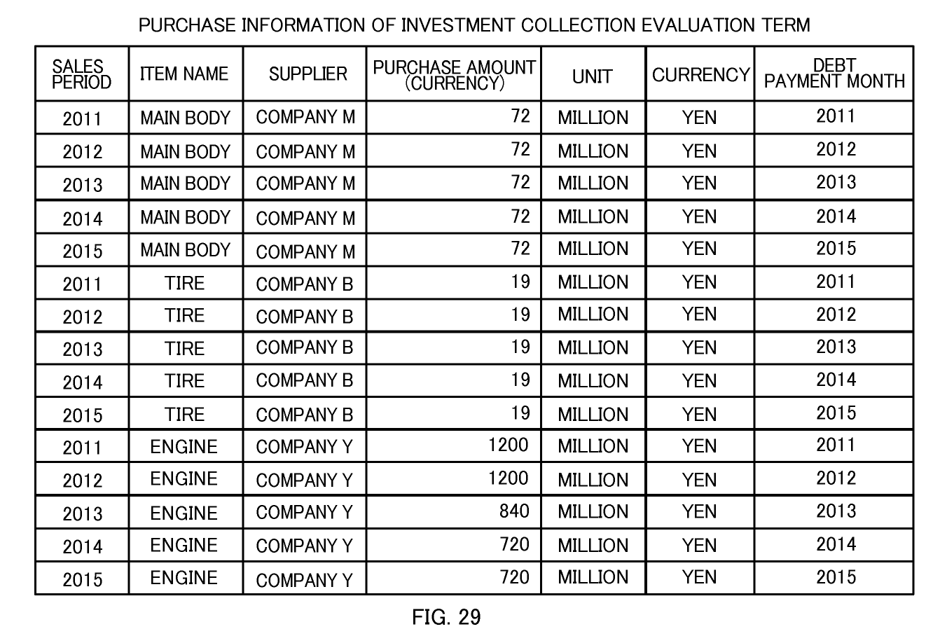

FIG. 29 depicts an example of the purchase information of the investment collection evaluation term calculated by the cash flow calculating unit 130 in the production simulation process S2330. In this purchase information, the purchase period column describes the period of purchase; the item name column describes the name of the purchased product; the supplier column describes the name of the supplier from which the product is purchased; the purchase amount (currency) column describes the purchase amount of the corresponding record; the unit column describes the unit of the sales amount; the currency column describes the currency of the sales amount; and the debt payment period describes a period when the accounts payable is paid.

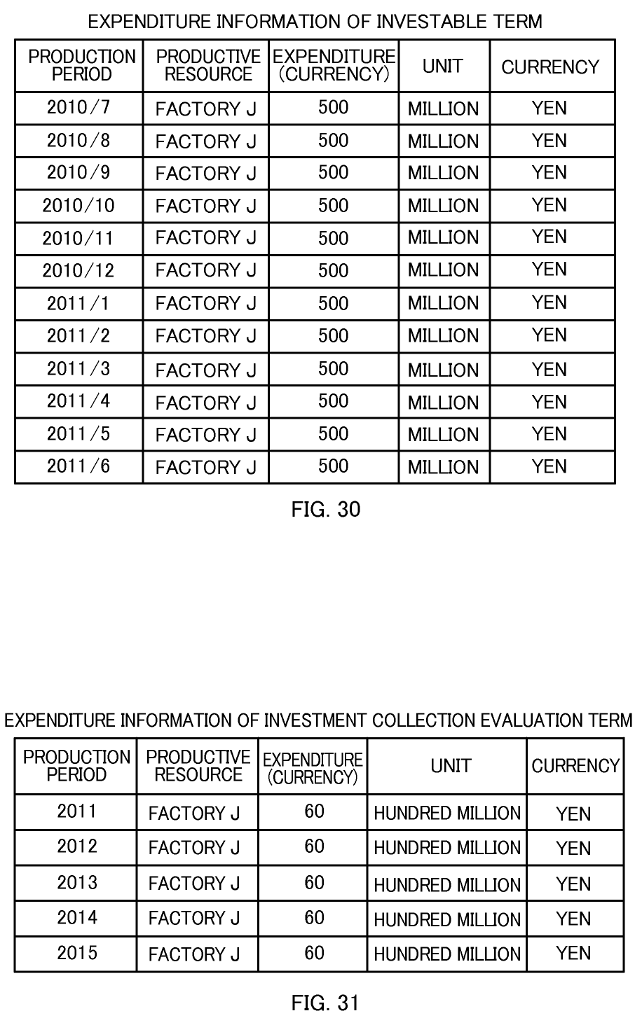

FIG. 30 is an example of the expenditure information generated in the resources of production of the investable term calculated by the cash flow calculating unit 130 in the production simulation process S2330. In this expenditure information, the production period describes the period of production; the resources of production column describes the name of the resources of production used; the expenditure (currency) column describes the expenditure of the corresponding record; the unit column describes the unit of the expenditure; and the currency column describes the currency of the expenditure. An expenditure debt payment period column may be added to the expenditure information to make a difference between the accrual period and the payment period of the expenditure.

FIG. 31 is an example of the expenditure information generated in the resources of production of the investment collection evaluation term calculated by the cash flow calculating unit 130 in the production simulation process S2330. In this expenditure information, the production period describes the period of production; the resources of production column describes the name of the resources of production used; the expenditure (currency) column describes the expenditure of the corresponding record; the unit column describes the unit of the expenditure; and the currency column describes the currency of the expenditure. An expenditure debt payment period column may be added to the expenditure information to make a difference between the generation period and the payment period of the expenditure.

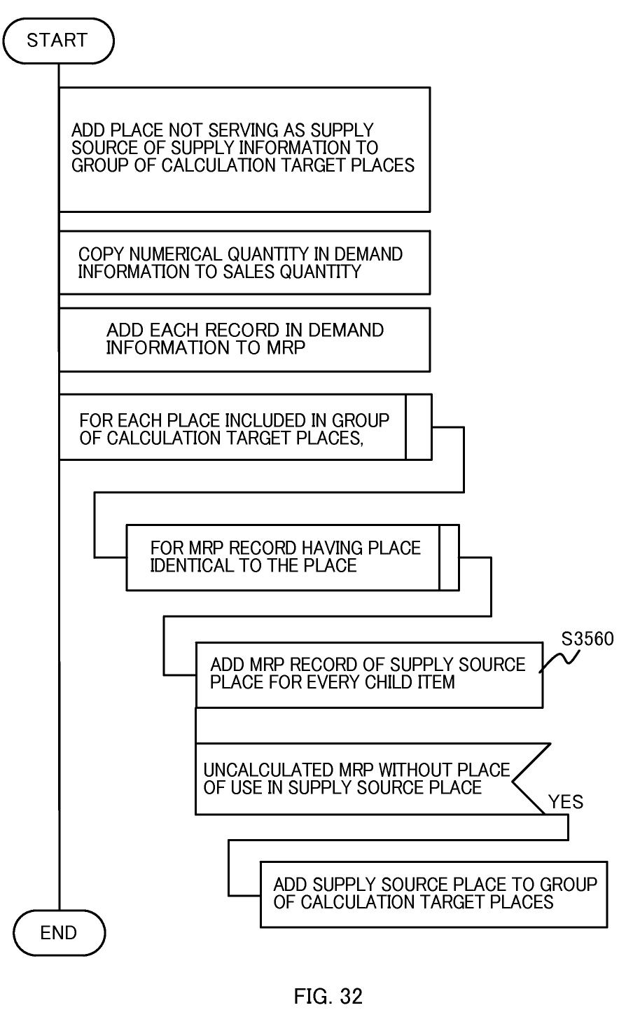

FIG. 32 depicts an example of the production simulation process S2330 executed by the cash flow calculating unit 130. In this embodiment, an example of executing an MRP development process with the monetary amount calculated and with accelerated production is described as the production simulation. The cash flow calculating unit 130 executes all the processes of adding a place not serving as a supply source in the supply information to a group of calculation target places, copying a numerical quantity in the demand information to the sales quantity, adding each record in the demand information to MRP, and the following processes, for each place included in the group of calculation target places. Specifically, for an MRP record having a place identical to the corresponding place, the processes of adding an MRP record of a supply source place for every child item, an uncalculated MRP without a place of use in a supply source place, and adding a supply source place to the group of calculation target places are executed. A conventional concept may be applied as the process concept of the MRP. The following is an example of the supply source MRP record generating method in the MRP record adding process S3560 of a supply source place executed by the cash flow calculating unit 130.

Item=an item of the corresponding MRP record;
Place=a supply source of a record
matching an item of the corresponding MRP record and
having a place of the corresponding MRP as the place of use in the supply information;
   Period=a period of the corresponding MRP record
− a lead time of the supply information
− a lead time of a record matching the item and the place of the corresponding MRP record in factory information;
   Numerical Quantity=a numerical quantity of the corresponding MRP
× the number of records matching a parent item of the product configuration information

Note: if the cumulative number in the supply source place exceeds the production capacity defined in the factory information, a maximum numerical quantity not exceeding the production capacity is used (if a numerical quantity is changed, a sales quantity of related demand is changed to a corresponding numerical quantity and MRP calculation is performed again for the changed portion);

### Monetary Amount of Purchase

if the place of the generated MRP record is a factory,
the purchase amount=0,
if the place of the generated MRP record is a supplier,
the purchase amount=numerical quantity
× unit price of a record having the item and the place of the unit purchase price information identical to the item and the place of the generated MRP record; and the

### Debt Payment Period

if the place of the generated MRP record is a factory,
debt payment period=period of the generated MRP record,
if a place of a generated MRP record is a supplier,
debt payment period=period of the generated MRP record
+ period until payment of accounts payable of the record having the place of the supplier information identical to the place of the generated MRP record.

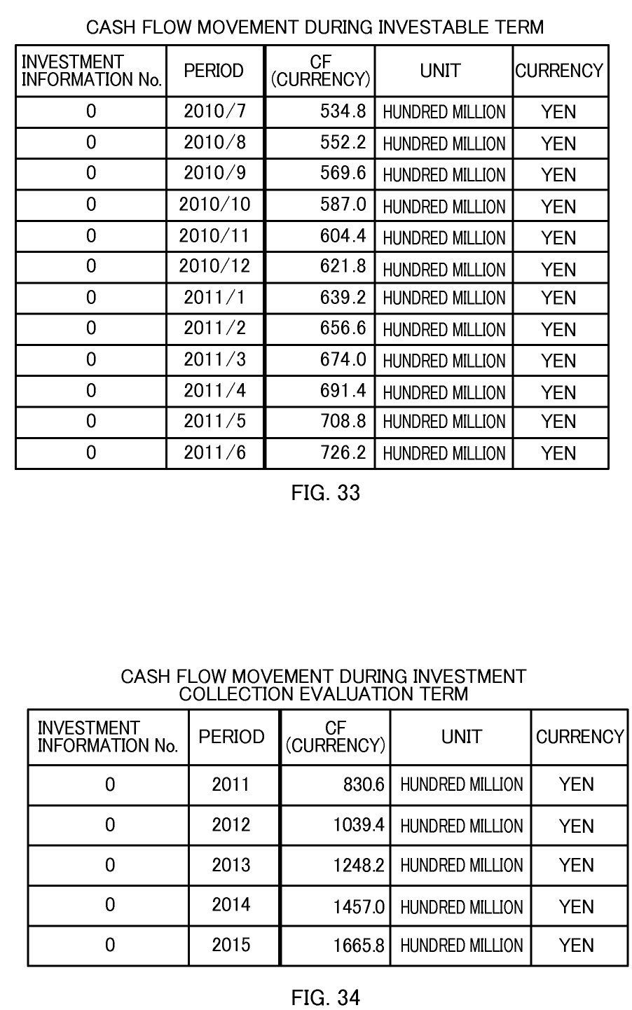

FIG. 33 depicts cash flow movement during the investable term calculated by the cash flow calculating unit 130. In this cash flow movement, the investment information number column has described therein the investment information number; the period column has described therein the period; the CF (currency) column has described therein the cash flow from the current time point to the corresponding record period; the unit column has described therein the unit of the cash flow, and the currency column has described therein the currency of the cash flow. The investment information number is the number assigned in the process of generating all the combinations of records of the investment menu information S3910 and is set to “0” when no investment is performed.

FIG. 34 depicts cash flow movement during the investment collection evaluation term calculated by the cash flow calculating unit 130. In this cash flow movement, the investment information number column has described therein the investment information number; the period column has described therein the period; the CF (currency) column has described therein the cash flow from the current time point to the corresponding record period; the unit column has described therein the unit of the cash flow, and the currency column has described therein the currency of the cash flow.

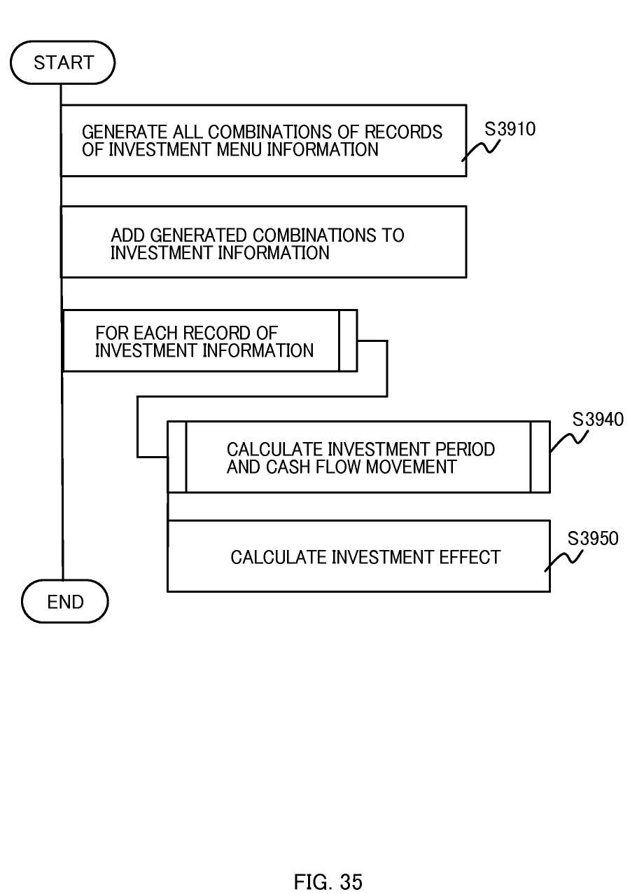

FIG. 35 is a diagram of process details of the investment period and cash flow calculation process S340 executed by the investment plan calculating unit 140. In this case, the investment plan calculating unit 140 executes the processes of generating all the combinations of records of the investment menu information (S3910), adding the generated combinations to the investment information, and calculating an investment period and cash flow movement (S3940) and calculating an investment effect (S3950) for each record of the investment information. The investment plan calculating unit 140 stores the investment information calculated in this way into the storage unit 120.

In the investment effect calculation process S3950, the investment plan calculating unit 140 acquires the cash flow of the last period of the investment evaluation period cash flow movement stored in the storage unit 120 and acquires an investment amount of a corresponding record of the investment information to calculate the investment effect as (the cash flow of the last period of the investment−the cash flow of the last period without investment)/the investment amount. The investment effect may be calculated by using a current value obtained by multiplying cash flow of each period by a discount rate.

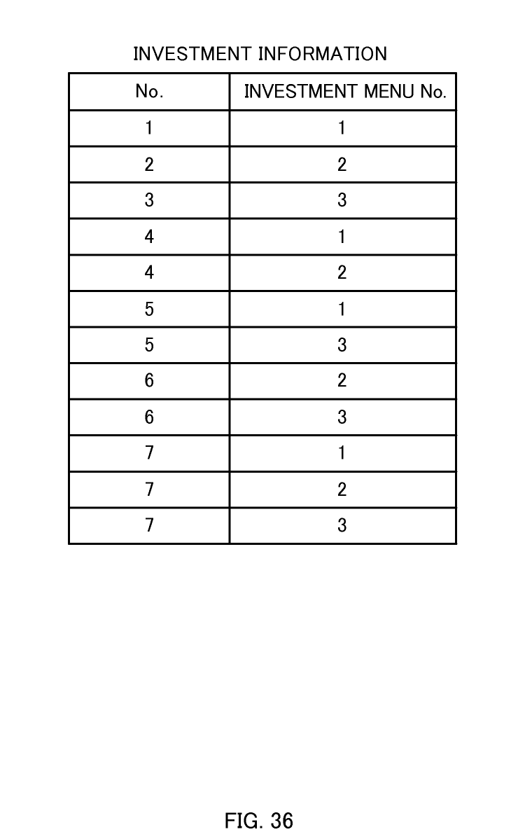

FIG. 36 depicts an example of the investment information generated by the investment plan calculating unit 140 and stored in the storage unit 120. In this investment information, the number column has described therein the number of investment information and the investment menu number column has described therein the number of the investment information menu making up the investment information of the corresponding record.

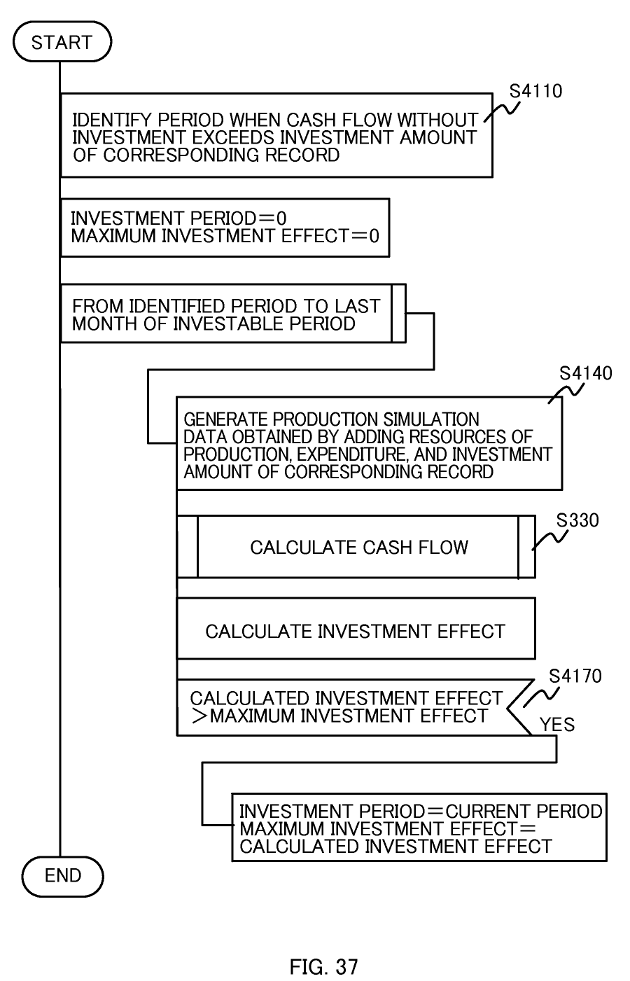

FIG. 37 is a diagram of process details of the investment period and cash flow movement calculation process S3940 executed by the investment plan calculating unit 140. In this case, the investment plan calculating unit 140 identifies the period when cash flow without investment exceeds the investment amount of the corresponding record (S4110), defines that the investment period equals zero and the maximum investment effect equals zero, and executes the process of generating production simulation data obtained by adding the resources of production, the expenditure, and the investment amount of the corresponding record from the identified period to the last month of the investable period, and the processes of calculating cash flow, calculating an investment effect, determining whether the calculated investment effect is greater than the maximum investment effect, and defining that the investment period is equal to the current period maximum investment effect further being equal to the calculated investment effect.

Although the investment effects are compared to calculate the investment period bringing out the maximum investment effect at S4170 in this process, the item compared may be changed, for example, the cash flows of the last period of the investment collection period are compared, so as to make a change to a suitable item. The investment plan calculating unit 140 adds the calculated investment period to an investment period column of the investment information.

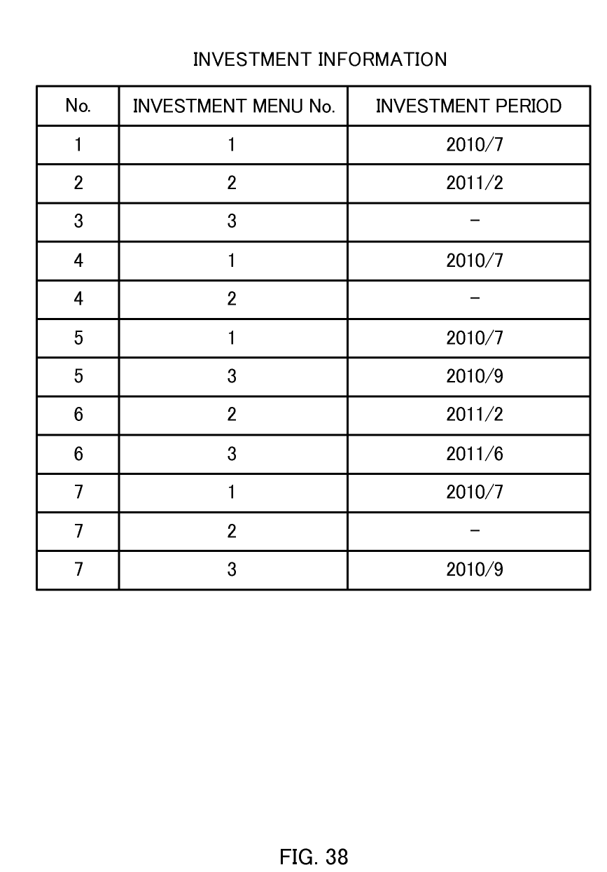

FIG. 38 depicts an example of the investment information after execution of the investment period and cash flow movement calculation process S3940. The investment period calculated by the investment plan calculating unit 140 is described in the investment period column in addition to the investment information of FIG. 36. An investment menu of an investment infeasible due to insufficient fund in hand has “−” described in the investment period.

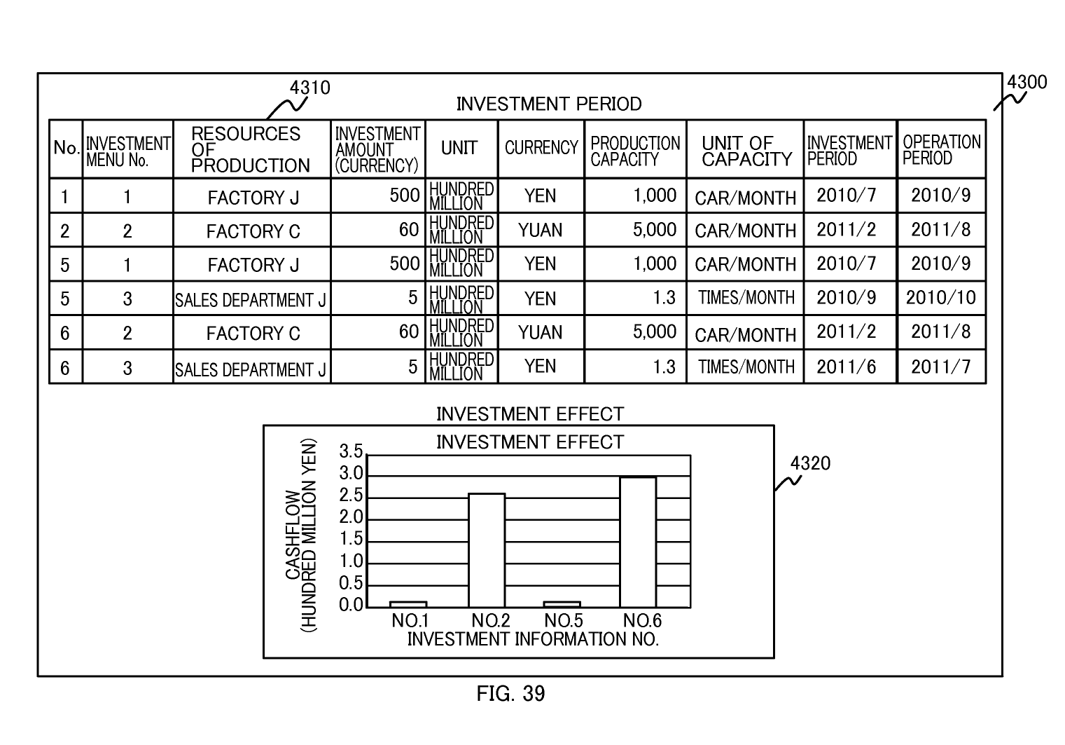

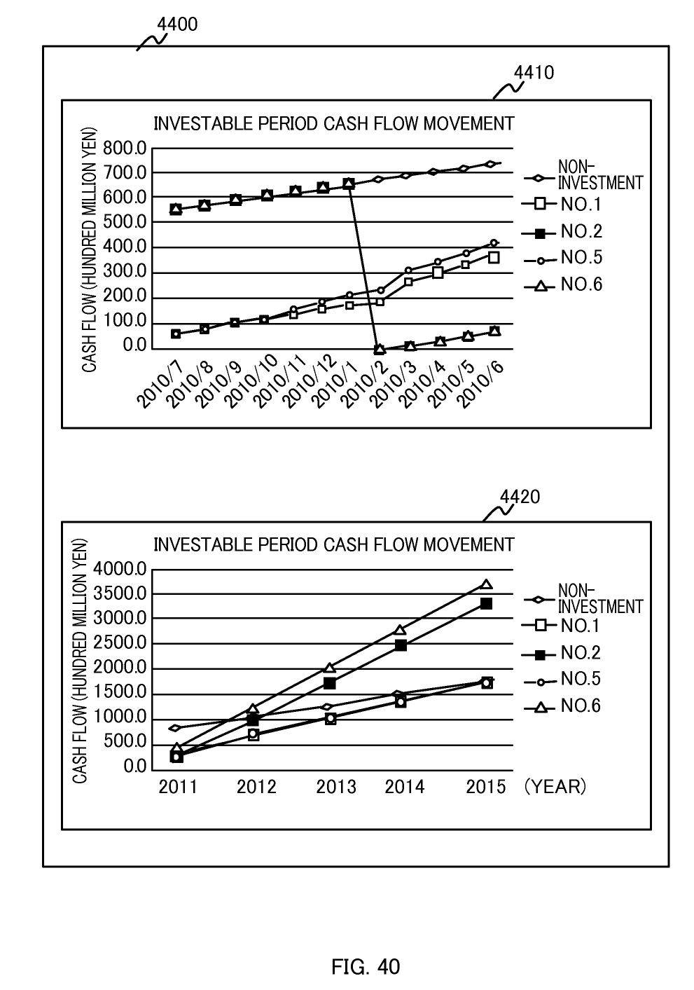

FIG. 39 depicts an example of a result screen displayed by the display unit 150 by the result displaying process S350. The result screen 4300 has an investment period table 4310 and an investment effect graph 4320. FIG. 40 depicts an example of a result screen displayed by the display unit 150 by the result displaying process S350. The result screen 4400 has an investable period cash flow movement graph 4410 and an investment collection evaluation period cash flow movement graph 4420.

The investable period cash flow movement graph 4410 is a graph created with the cash flow movement corresponding to the investment number of the investable period and is created and displayed on the display unit 150 using the investable period cash flow movement information stored in the storage unit 120.

The investment collection evaluation period cash flow movement graph 4420 is a graph created from the cash flow movement corresponding to the investment number of the investment collection evaluation period and is created and displayed on the display unit 150 using the investable period cash flow movement information stored in the storage unit 120.

A user can check the investable period cash flow movement graph 4410 to accurately comprehend a status of funds in hand at the time of investment. The user can check the investment collection evaluation period cash flow movement graph 4420 to confirm a status of collection of the investment and can also check the investment effect graph 4320 to select a highly effective investment.

### Second Embodiment

In this embodiment, description will be made of an example of an investment plan planning apparatus evaluating an investment effect including financing (i.e., external procurement funds) in addition to cash flow from a company's own production activity on the assumption that funds can be financed by issuing cooperate bonds or by a loan from an external institution so as to work out a suitable investment plan. In this embodiment, only the portions different from the investment plan planning apparatus 100 of the first embodiment will be described. An example of a block diagram of a functional configuration of the investment plan planning apparatus of this embodiment is the same as FIG. 1.

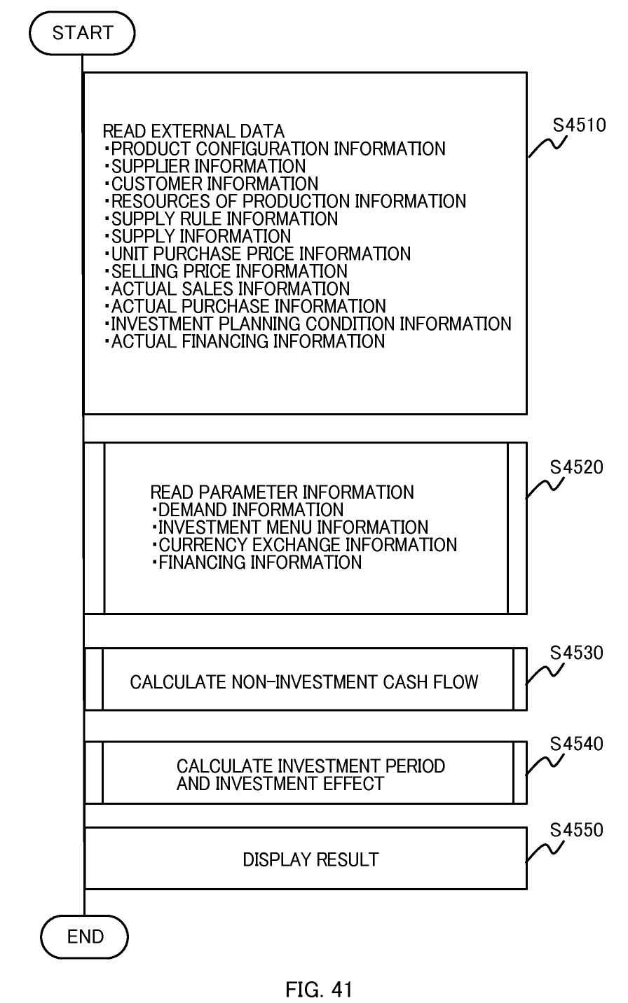

FIG. 41 is a diagram of a process flow example of an investment plan planning method according to this embodiment. In this case, in the external data reading process S4510, the input unit 110 reads and stores actual financing information into the storage unit 120 in addition to the external data reading process S310 of the investment plan planning apparatus 100. In the parameter information reading process S4520, reading of financing information is added to the parameter information reading process S320 of the investment plan planning apparatus 100. In the non-investment cash flow calculation process S4530, increase and decrease of cash flow due to financing and repayment of funds is calculated in addition to the non-investment cash flow calculation process S330 of the investment plan planning apparatus 100.

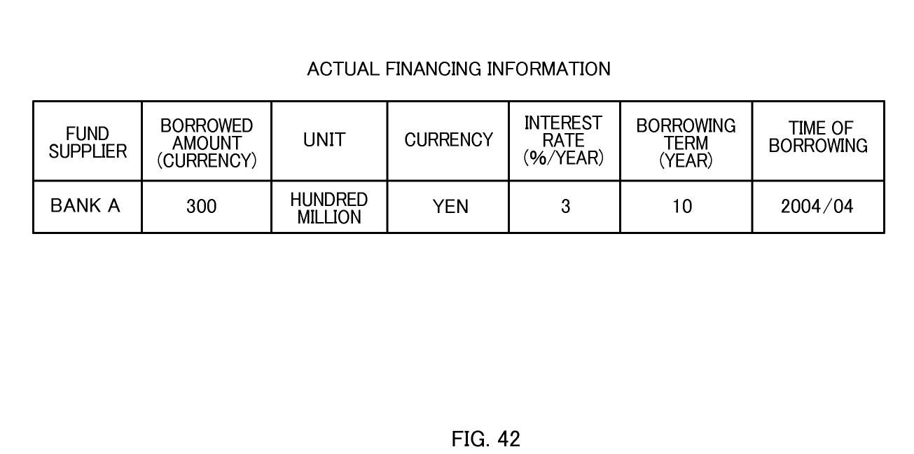

FIG. 42 is an example of actual financing information. In this actual financing information, the fund supplier column has described therein the name of the supplier of the funds; the borrowed amount (currency) column has described therein the borrowed amount; the unit column has described therein the unit of the borrowed amount; the currency column has described therein the currency of the borrowed amount; the interest rate column has described therein the borrowing interest rate; the borrowing term column has described therein the term of borrowing; and the borrowing time column has described therein the time of borrowing.

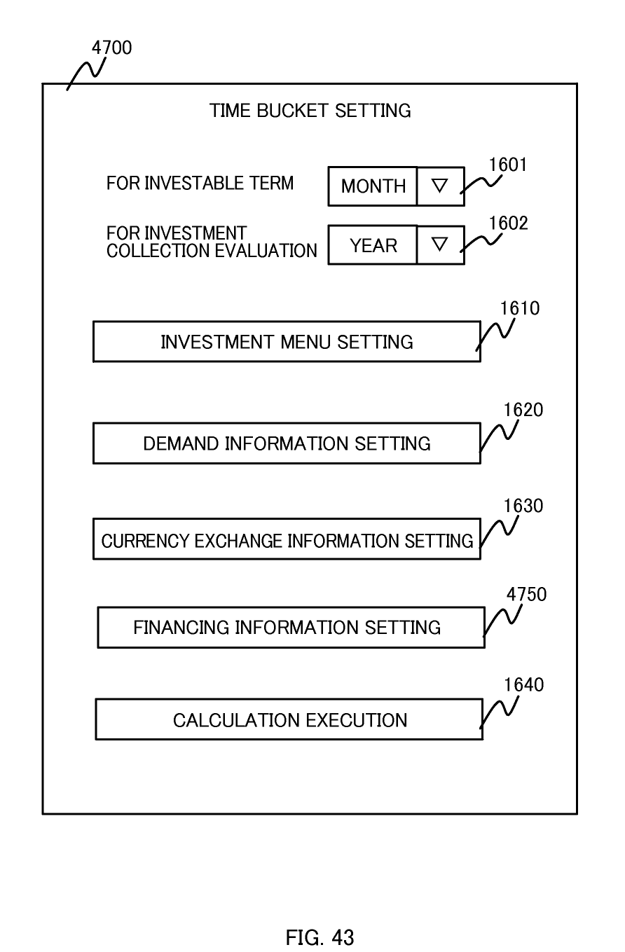

FIG. 43 is a diagram of an example of a parameter information input screen. This parameter information input screen 4700 has a financing information setting icon 4750 in addition to the parameter information input screen 1600 of the investment plan planning apparatus 100. The financing information setting icon 4750 receives an input from a user through the input device 250. When a user selects the financing information setting icon 4750, the display unit 150 displays a financing information configuration screen 4800.

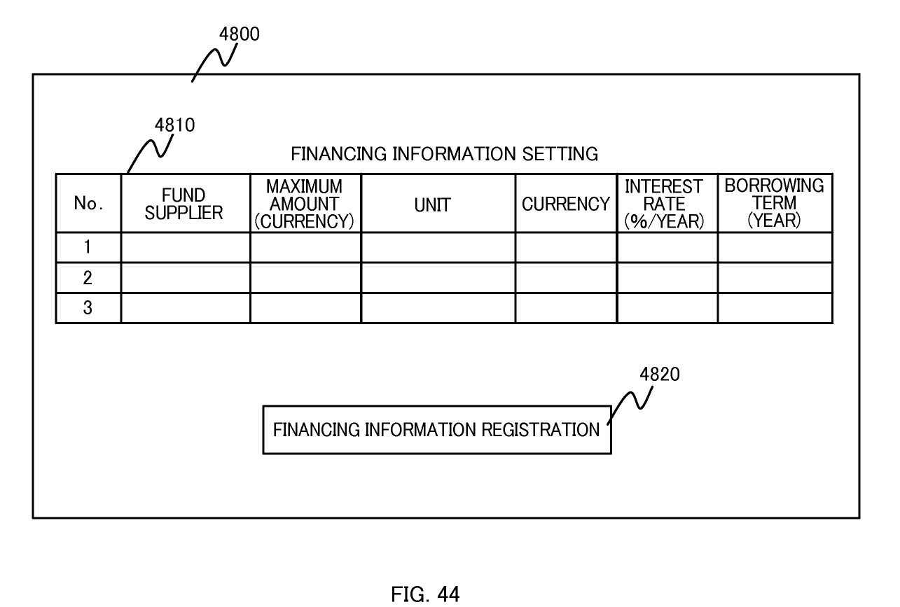

FIG. 44 depicts an example of the financing information configuration screen. The financing information configuration screen 4800 has a financial information setting data grid 4810 and a financial information setup icon 4820. The financial information setting data grid 4810 receives input from a user through the input device 250. The user inputs through the input device 250 the name of supplier of funds into the fund supplier column, the maximum amount of funds that can be financed from the fund supplier of the corresponding record into the maximum amount (currency) column, the unit of the maximum amount into the unit column, the currency of the maximum amount into the currency column, the interest rate of the financing method of the corresponding record into the interest rate (%/year), and the borrowing term of the financing method of the corresponding record into the borrowing term (year) column. The setting of the financing information may be performed with not only the method of allowing input to the data grid 4810 but also a method such as reading a text file in which the financing information is entered.

The financial information setting icon 4820 receives input from a user through the input device 250. When the user selects the financial information setting icon 4820, the input unit 110 reads the information input to the financial information setting data grid 4810 and stores the information into the storage unit 120. The display unit 150 displays the parameter information input screen 4700.

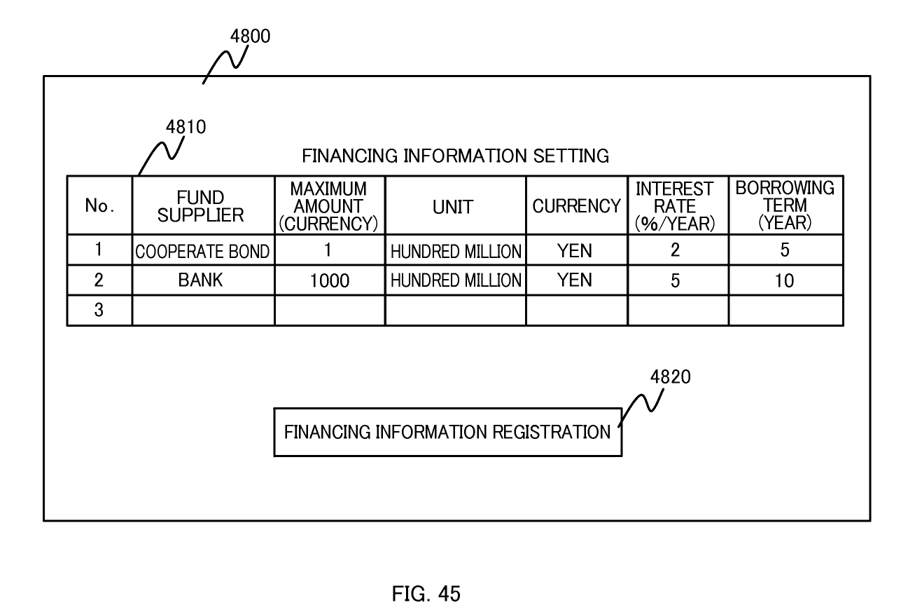

FIG. 45 depicts an example of the financial information configuration screen 4800 after a user inputs data through the input device 250 to the financial information setting data grid 4810.

Equation (4) used in a cash flow calculation process of each time bucket executed by the cash flow calculating unit 130 will be described. In Equation (4), an increase in cash flow due to repayment and borrowing of funds due for repayment is added to the cash flow calculation equation (Eq. 3) of each time bucket used by the investment plan planning apparatus 100.

$$cash flow of each time bucket = sales amount of a record having an identical debt collection period in the actual sales information \times the exchange rate of the time bucket + sales amount of a record having an identical debt collection period in the sales information \times the exchange rate of the time bucket - expenditure of the resources of production \times the exchange rate of the time bucket - purchase amount of a record having an identical debt payment period in the actual purchase \times the exchange rate of the time bucket - purchase amount of a record having an identical debt payment period in the purchase information \times the exchange rate of the time bucket + borrowed amount of a record having an identical borrowing period \times the exchange rate of the time bucket - borrowed amount of a record having an identical repayment period \times the exchange rate of the time bucket - borrowed amount \times interest rate for time bucket \times the exchange rate of the time bucket \qquad Eq . 4$$

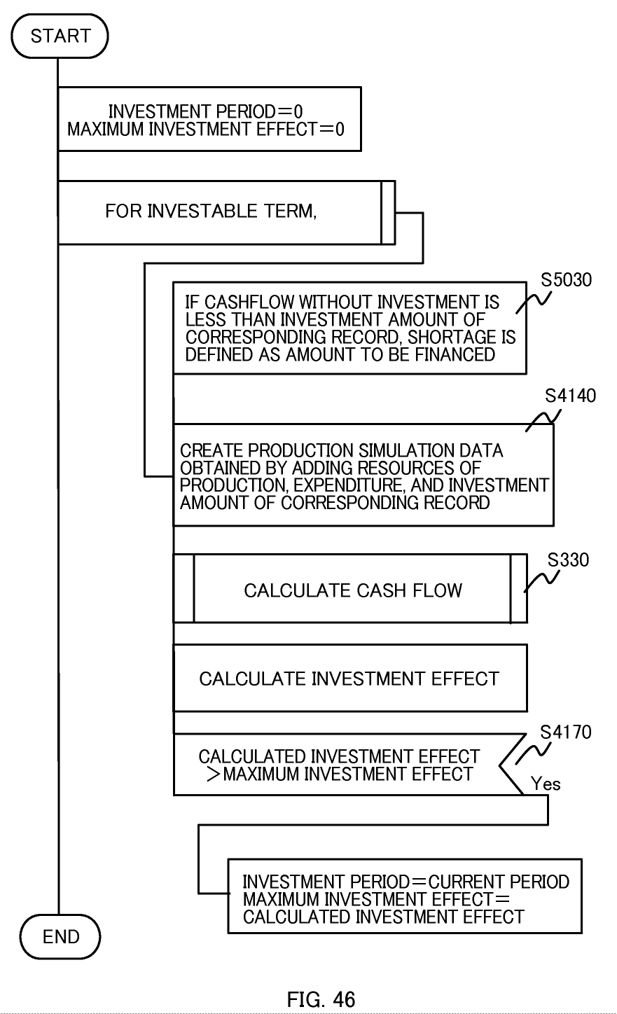

FIG. 46 depicts details of the investment period and investment effect calculating process S4540 executed by the investment plan calculating unit 140. Here, as in the case of the flow of FIG. 37, the investment plan calculating unit 140 defines the investment period to equal zero and the maximum investment effect to equal zero, and executes a process of defining the shortage as the amount to be financed when non-investment cash flow is less than an investment amount of the corresponding record for an investable period, and executes the processes of generating production simulation data obtained by adding the resources of production, the expenditure, and the investment amount of the corresponding record, calculating the cash flow, calculating the investment effect, determining whether the calculated investment effect is greater than the maximum investment effect, and defining the investment period having the current period maximum investment effect which is the calculated investment effect (the investment period is defined as the period when the current period maximum investment effect can be obtained).

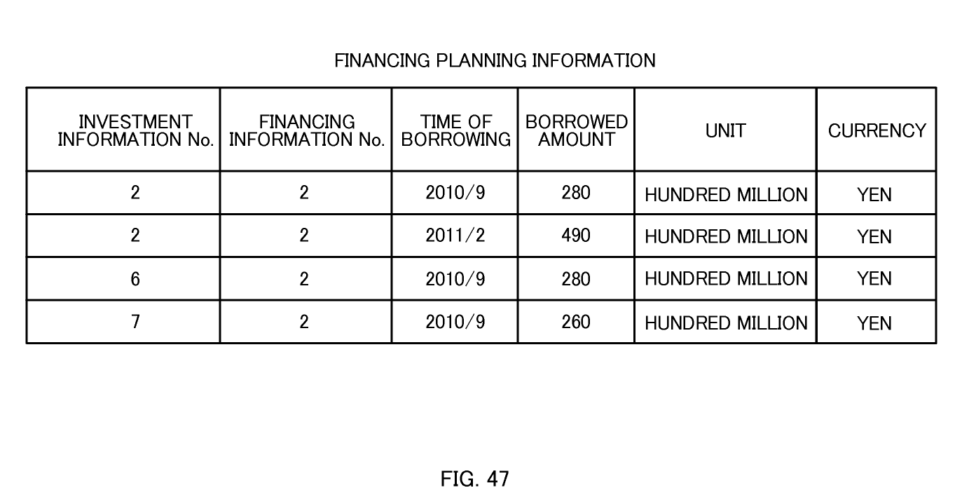

FIG. 47 depicts an example of financing planning information calculated in the process S5030 of defining the shortage as the amount to be financed when the cash flow without investment is less than the investment amount of a corresponding record. In the financing planning information, the investment information number column has described therein the investment information number; the financing information number column has described therein the financing number; the borrowing time column has described therein the scheduled borrowing time; the borrowed amount column has described therein the scheduled borrowed amount; the unit column has described therein the unit of the borrowed amount; and the currency column has described therein the currency of the borrowed amount. In the result displaying process S4550 (FIG. 41), this financing planning information may be displayed in addition to the result screen of the investment plan planning apparatus 100.

A user can check the financing planning information in addition to the result obtained with the investment plan planning apparatus 100 to determine an investment plan after confirming the fund supplier and the borrowing period.

### Third Embodiment

In this embodiment, description will be made of an example of an investment plan planning apparatus evaluating an investment effect in terms of investment funds acquired from capital providers specified in advance by the user (items specified by the user) so as to calculate a suitable investment plan. In this embodiment, only the parts different from the investment plan planning apparatus 100 of the first embodiment will be described. A functional configuration of the investment plan planning apparatus of this embodiment is the same as the investment plan planning apparatus 100 of FIG. 1.

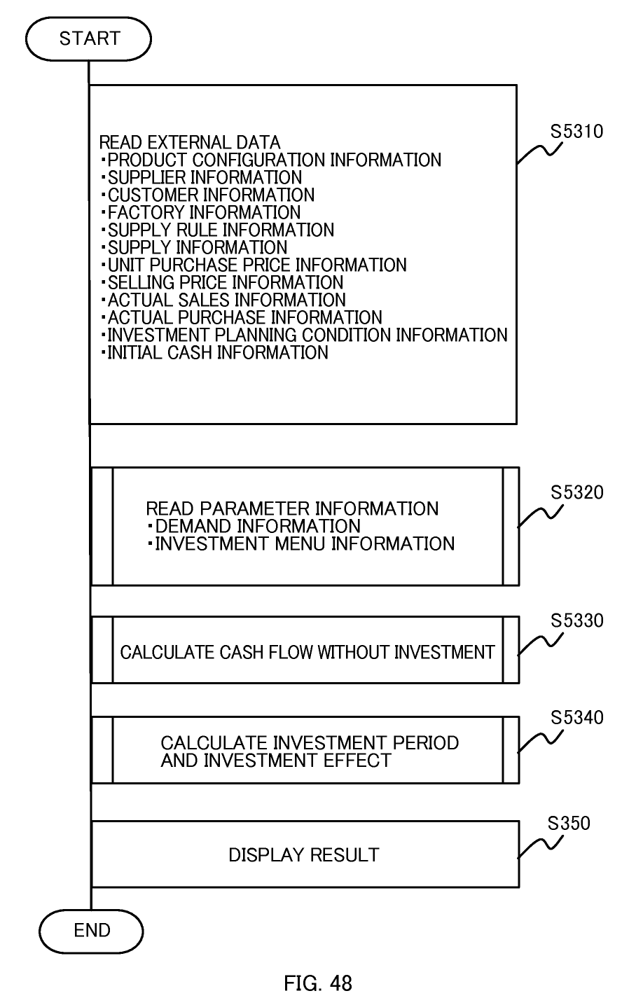

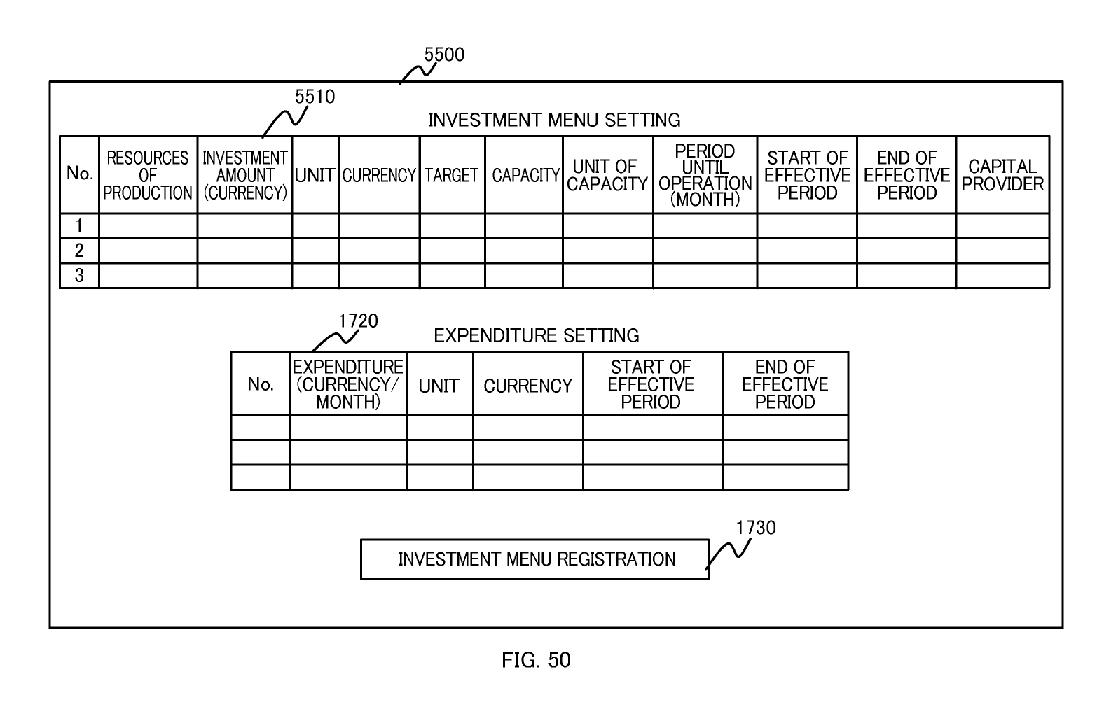

FIG. 48 is a diagram of a process flow example of an investment plan planning method of this embodiment. In the external data reading process S5310 in this case, a process is executed for reading and storing initial cash information into the storage unit 120 in addition to the external data reading process S310 performed by the investment plan planning apparatus 100 of the first embodiment. A parameter information reading process S5320 is the same as the process performed by the investment plan planning apparatus 100 of the first embodiment. However, the investment menu configuration screen displayed by the display unit 150 is the investment menu configuration screen 5500 depicted in FIG. 50.

In the non-investment cash flow calculation process S5330, the cash flow calculation equation (Eq. 3) is applied for each capital provider of the investment in the cash flow movement calculation process S2340 to calculate cash flow of each capital provider and store the results into the storage unit 120.

In the investment period and investment effect calculating process S5340, the investment plan calculating unit 140 reads the cash flow calculated for each capital provider of investment from the storage unit 120, judges the feasibility of the investment for each of the capital providers defined in the investment information, and determines an investment period to calculate the cash flow.

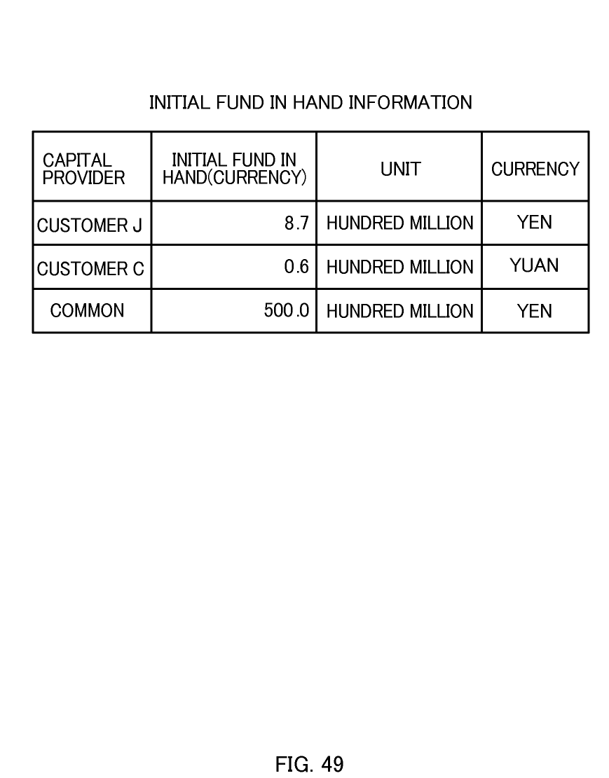

FIG. 49 is an example of initial fund in hand information. In the initial fund in hand information, the capital provider column has described therein the customer name; the initial fund in hand (currency) column has described therein the funds retained by the capital provider of a corresponding record at the beginning of the investment plan; the currency column has described therein the unit of the initial fund in hand; and the currency has described therein the currency of the initial fund in hand.

FIG. 50 is an example of an investment menu configuration screen according to this embodiment. The investment menu configuration screen 5500 has an investment menu setting data grid 5510 changed from the investment menu setting data grid 1710 of the investment menu configuration screen 1700 of the investment plan planning apparatus 100. In the investment menu setting data grid 5510, the capital provider column is added to the investment menu setting data grid 1710. The customer providing capital of investment of the corresponding record is input to the capital provider column.

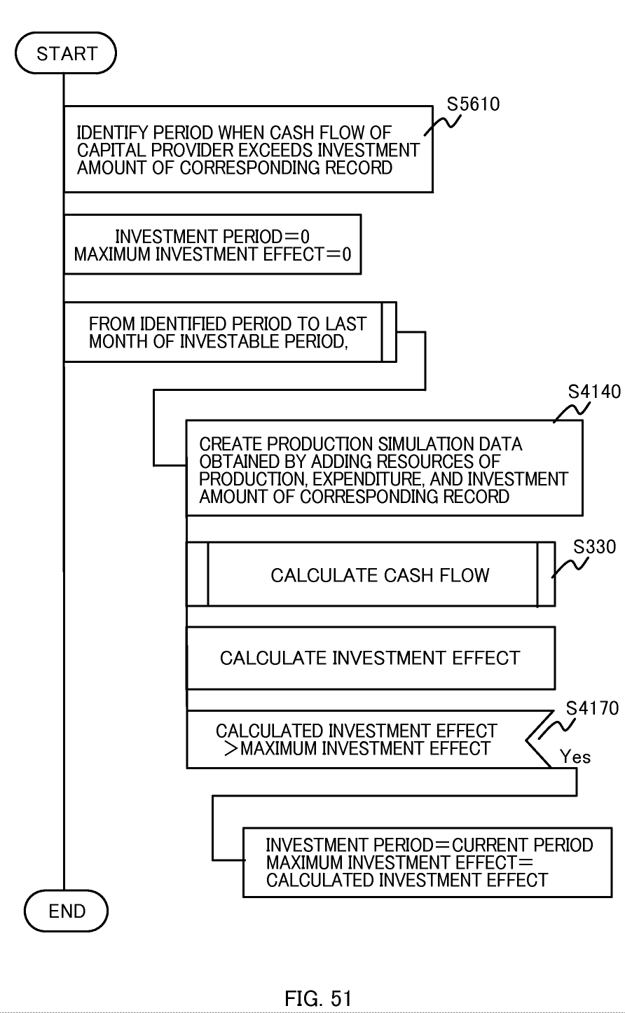

FIG. 51 depicts process details of the investment period and cash flow movement calculation process S3940 performed by the investment plan calculating unit 140. The difference from a similar process in the first embodiment is that in the process of determining excess or deficiency of an investment amount S5610, cash flow of the capital provider is compared with the investment amount.

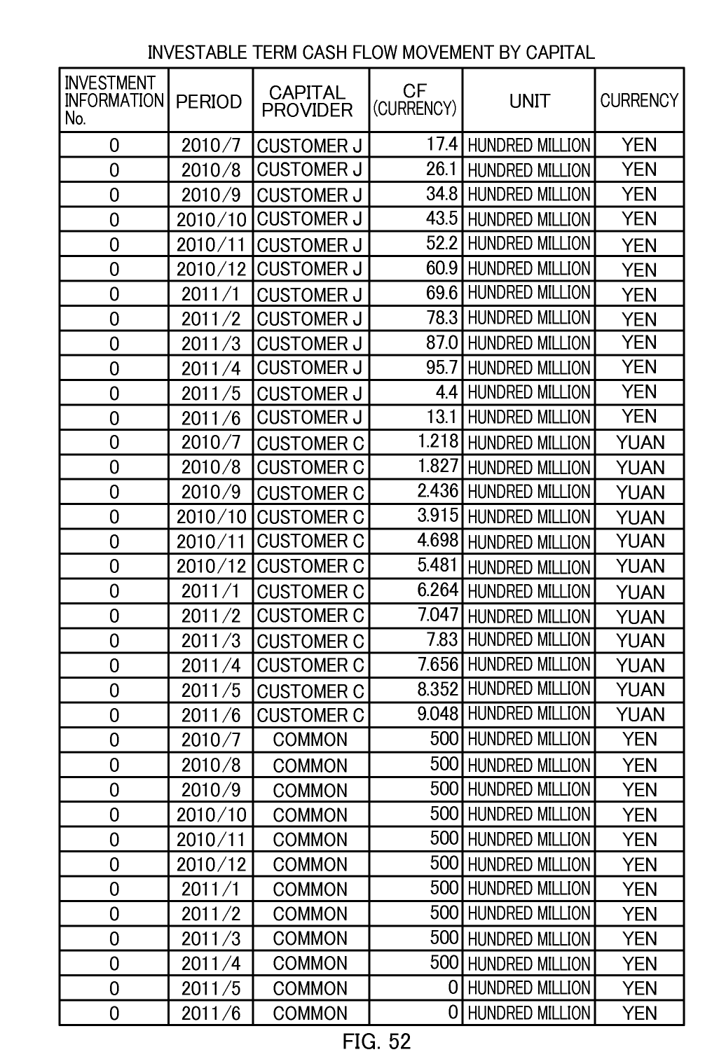

FIG. 52 depicts an example of information of investable term cash flow movement by capital. In the investable term cash flow movement by capital, the investment information number column has described therein the investment information number; the period column has described therein the period; the capital provider column has described therein the name of customer providing capital; the CF (currency) column has described therein the cash flow from the current time point to the period of the corresponding record; the unit has described therein the unit of the cash flow; and the currency has described therein the currency of the cash flow.

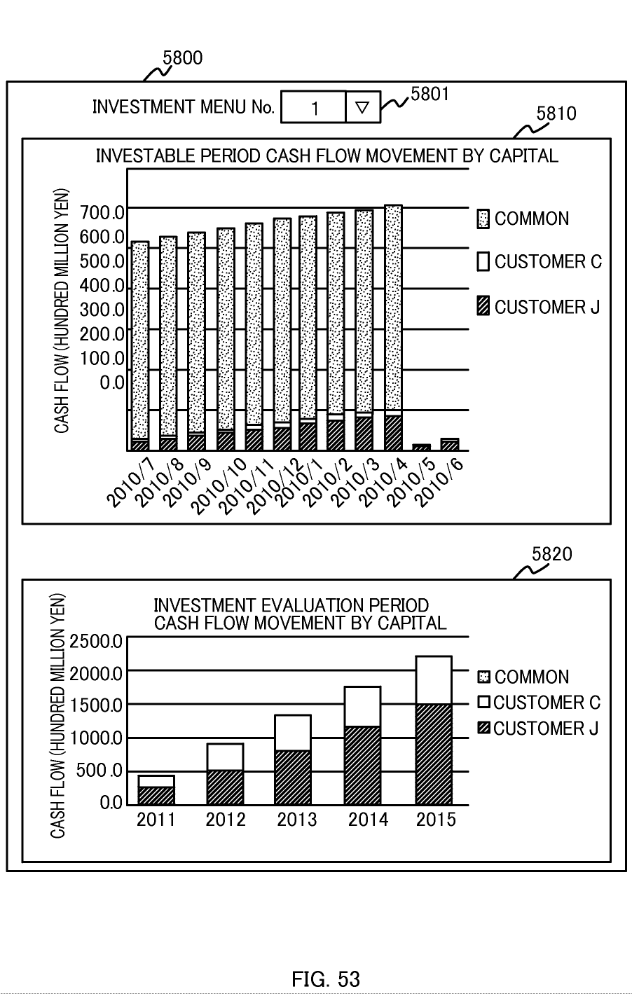

FIG. 53 depicts an example of a result screen displayed by the display unit 150 at the result displaying process S350. The result screen 5800 has an investment menu number selection box 5801, a graph of investable period cash flow movement by capital 5810, and a graph of investment evaluation period cash flow movement by capital 5820.

The display unit 150 preliminarily creates and displays a list of investment menu numbers in the investment menu number selection box 5801. When a user selects an investment menu number in the investment menu number selection box 5801, the display unit 150 creates a graph of investable period cash flow movement by capital 5810 from the information of investable period cash flow information by capital stored in the storage unit 120 and creates a graph of investment evaluation period cash flow movement by capital 5820 from the information of investment evaluation period cash flow information by capital to display the graphs.

The user can check the result screen 5800 to confirm that the capital of investment is provided by the specified capital provider; that investment expenses are shared in accordance with the collection ability of the capital provider; the collection period of the investment, etc., before determining an investment plan.

The present invention is not limited to the embodiments above and includes various modifications. For example, the embodiments are described in detail for facilitating the understanding of the present invention and are not necessarily limited to those including all the described constituent elements. Further, a part of the constituent elements of a certain embodiment can be replaceable with a constituent element of another embodiment or a constituent element of another embodiment can be added to the constituent elements of a certain embodiment. Furthermore, a part of the constituent elements of the embodiments can be added, be deleted, or replaced with another constituent element.

The constituent elements, the functions, the processes, the processing means and the like, described above may be implemented as hardware by designing an integrated circuit, for example. The constituent elements, the functions and the like, described above may be implemented as software by a processor interpreting and executing programs implementing the respective functions. Information of programs, tables, files and the like, implementing the functions may be placed in a recording device such as a memory, a hard disk, and an SSD (solid state drive) or a storage medium such as an IC card, an SD card, and DVD.

The control lines and the information lines described are those considered to be necessary for explanation and all the control and information lines may not be described in terms of a product. Actually it may be considered that almost all the constituent elements are connected to each other.

Although the best modes for carrying out the invention have been specifically described, the present invention is not limited thereto and can be modified in various ways without departing from the spirit thereof.

According to the embodiments, for example, if demand recovers after making the investment plan and the future fund in hand increases as compared to when the investment was planned, the fund in hand and the investment effect at future time points can be evaluated to calculate a suitable investment plan. Therefore, a suitable investment plan can be worked out based on the evaluation of the fund in hand and the investment effect. As a result, investment can be performed leaving a margin for funds in hand, and investment will be performed only when a sufficient return can be expected from the investment, which promotes sustained corporate growth.

Therefore, a suitable investment period and an investment amount can be determined by calculating funds in hand at the time of investment and evaluating an investment effect.

The description herein at least reveals the following. That is, in the investment plan planning apparatus, based on the specified investable period and a period for evaluating collection of investment received by the input unit from a user, the computing unit may set the investment period within the investable period and evaluate the investment effect for the period during which collection of investment is evaluated.

In the investment plan planning apparatus, for a time bucket of the period during which collection of investment is evaluated, the computing unit can receive with the input unit a value equal to or greater than the time bucket of the investable period.

In the investment plan planning apparatus, the storage unit may further store expenses for business activities for selling products as targets of investment and prediction information of actual sales increased by each expenditure, and the computing unit may perform processes of comparing the movement of the calculated cash flow acquired when the cash flow is not used for investment with a user-defined investment amount including the business activity expenditure, identifying a period when an amount of the cash flow exceeds the investment amount as an investable period, calculating funds in hand and an investment effect when the funds in hand are invested in the business activity expenditure for the investable period, and identifying the investment period causing the maximum investment effect and the investment amount thereof.

Additionally, in the investment plan planning apparatus, the computing unit may define the funds in hand at the accounting period closest to the time of planning as the initial fund in hand to calculate the movement of the cash flow starting with the initial fund in hand.

Further, in the investment plan planning apparatus, the computing unit may add the amount of external procurement funds specified by the user through the input unit to funds obtained from accounts receivable based on product sales, and perform a calculation of the cash flow to calculate the investment effect.

Further still, in the investment plan planning apparatus, the computing unit may, with regard to the calculated cash flow, compare the movement thereof when the cash flow is not used for investment with an investment amount defined by the user through the input unit, identify the period when the amount of the cash flow exceeds the investment amount as an investable period, calculate the external procurement funds and the investment effect when the external procurement funds are invested for the investable period, and identify the investment period causing the maximum investment effect with the external procurement funds and the amount of the external procurement funds at the time.

Yet further still, in the investment plan planning apparatus, the computing unit may include a repayment amount of external procurement funds into the accounts payable payment amount and execute the cash flow calculation process.

Even further still, in the investment plan planning apparatus, the computing unit may use only a monetary amount relating to an item specified by the user through the input unit among the accounts receivable collection amount and perform the cash flow calculation process to evaluate the investment effect when the investment is performed by using the amount of the specified item as capital.

Even further still, in the investment plan planning apparatus, the computing unit may change the evaluation criterion of calculation of an investment period to a predetermined criterion of either an investment effect or a cash flow amount specified by a user through the input unit and perform the process of identifying an investment period and an investment amount thereof.

Even further still, in the investment plan planning apparatus, the computing unit may identify investment amounts for a plurality of investment periods of the same investment target and calculate an investment effect for each of the plurality of investment periods.

### REFERENCE SIGNS LIST

100 Investment plan planning apparatus
110 Input unit
120 Storage unit
130 Cash flow calculating unit
140 Investment plan calculating unit
150 Display unit
1600, 4700 Parameter information input screen
1700, 5500 Investment menu configuration screen
1900 Demand information configuration screen
2100 Currency exchange configuration screen
4300 Investment period calculation result screen
4400 Cash flow movement calculation result screen
4800 Financing information configuration screen
5800 Calculation result screen of cash flow movement by capital

1. An investment plan planning apparatus being a computer apparatus that evaluates a fund in hand and an investment effect of the fund in hand to estimate an investment plan relating to product production, comprising:
an input unit that receives information from a user to store in a storage unit;
the storage unit stores at least prediction information related to a period for debt collection from a customer, prediction information related to a period for debt payment to a supplier, actual sales information of a product, demand information predicted for the product, and actual purchase information of items and services required for product production, received by the input unit from a user; and
a computing unit executing the processes of
identifying a collection period of accounts receivable related to a predetermined product from the actual sales information of the product, demand information of the product, and a prediction information of the debt collection period related to a customer of the product, identifying a payment period of accounts payable generated at a time of production of the product from an actual purchase information and the demand information related to the product, and calculating a cash flow by subtracting an accounts payable payment amount from an accounts receivable collection amount of each period,
comparing movement of the calculated cash flow for a case when the cash flow is not used for investment with an investment amount defined by a user through the input unit, identifying as an investable term a term when an amount of the cash flow exceeds the investment amount, calculating fund in hand and an investment effect when the fund in hand is invested in a user-specified investment target for the investable term, and identifying an investment period causing a maximum investment effect and an investment amount therefor, and
displaying the cash flow movement and pieces of information of the investment effect on a display unit.

2. The investment plan planning apparatus of claim 1, wherein
based on specifications of an investable term and a term for evaluating collection of investment received by the input unit from a user, the computing unit sets an investment period within the investable term and evaluates the investment effect for the term for evaluating collection of investment.

3. The investment plan planning apparatus of claim 2, characterized in that
the computing unit receives a value equal to or greater than a time bucket of the investable term as a time bucket of the term for evaluating collection of investment, with the input unit.

4. The investment plan planning apparatus of claim 1, wherein
the storage unit further stores a business activity expenditure for selling a product as a target of investment and prediction information of actual sales increased by each of the expenditure; and
the computing unit performs processes of comparing movement of the calculated cash flow acquired when the cash flow is not used for investment with a user-defined investment amount including the business activity expenditure, identifying a term when an amount of the cash flow exceeds the investment amount as an investable term, calculating a fund in hand and an investment effect when the fund in hand is invested in the business activity expenditure for the investable term, and identifying an investment period causing the maximum investment effect and an investment amount thereof.

5. The investment plan planning apparatus of claim 1, wherein
the computing unit sets a fund in hand at an accounting period closest to a time of planning as an initial fund in hand and calculates a movement of the cash flow starting with the initial fund in hand.

6. The investment plan planning apparatus of claim 1, wherein
the computing unit adds an amount of external procurement specified by a user through the input unit to a fund obtained from accounts receivable based on product sales and performs a calculation of the cash flow to calculate the investment effect.

7. The investment plan planning apparatus of claim 6, wherein
the computing unit, with regard to the calculated cash flow, compares movement thereof when the cash flow is not used for investment with an investment amount defined by a user through the input unit, identifies a term when an amount of the cash flow exceeds the investment amount as an investable term, calculates an external procurement fund and an investment effect when the external procurement fund is invested for the investable term, and identifies an investment period causing the maximum investment effect with the external procurement fund and an amount of the external procurement fund at the period.

8. The investment plan planning apparatus of claim 6, wherein
the computing unit includes a repayment amount of an external procurement fund in the accounts payable payment amount and executes the cash flow calculation process.

9. The investment plan planning apparatus of claim 1, wherein
the computing unit uses only a monetary amount relating to an item specified by the user through the input unit among the accounts receivable collection amount and performs the cash flow calculation process to evaluate an investment effect when an investment is performed by using the amount of the specified item as capital.

10. The investment plan planning apparatus of claim 1, wherein
the computing unit changes an evaluation criterion of calculation of an investment period to a predetermined criterion of either an investment effect or a cash flow amount specified by a user through the input unit and performs the process of identifying an investment period and an investment amount thereof.

11. The investment plan planning apparatus of claim 1, wherein
the computing unit identifies investment amounts for a plurality of investment periods of the same investment target and calculates an investment effect for each of the plurality of investment periods.

12. An investment plan planning method having
a computer apparatus including an input unit that receives information from a user to store in a storage unit, and the storage unit that stores at least prediction information related to a period for debt collection from a customer, prediction information related to a period for debt payment to a supplier, actual sales information of a product, demand information predicted for the product, and actual purchase information of items and services required for product production, received by the input unit from a user, to evaluate a fund in hand and an investment effect of the fund in hand, and
the computer apparatus executes the processes of
identifying a collection period of accounts receivable related to a predetermined product from the actual sales information of the product, demand information of the product, and a prediction information of the debt collection period related to a customer of the product, identifying a payment period of accounts payable generated at a time of production of the product from an actual purchase information and the demand information related to the product, and calculating a cash flow by subtracting an accounts payable payment amount from an accounts receivable collection amount of each period;
comparing movement of the calculated cash flow for a case when the cash flow is not used for investment with an investment amount defined by a user through the input unit, identifying as an investable term a term when an amount of the cash flow exceeds the investment amount, calculating fund in hand and an investment effect when the fund in hand is invested in a user-specified investment target for the investable term, and identifying an investment period causing a maximum investment effect and an investment amount therefor; and
displaying the cash flow movement and pieces of information of the investment effect on a display unit.

13. An investment plan planning program, causing a computer apparatus including an input unit that receives information from a user to store in a storage unit, and the storage unit that stores at least prediction information related to a period for debt collection from a customer, prediction information related to a period for debt payment to a supplier, actual sales information of a product, demand information predicted for the product, and actual purchase information of items and services required for product production, received by the input unit from a user, to evaluate a fund in hand and an investment effect of the fund in hand, to execute the steps of:
identifying a collection period of accounts receivable related to a predetermined product from the actual sales information of the product, demand information of the product, and a prediction information of the debt collection period related to a customer of the product, identifying a payment period of accounts payable generated at a time of production of the product from an actual purchase information and the demand information related to the product, and calculating a cash flow by subtracting an accounts payable payment amount from an accounts receivable collection amount of each period;
comparing movement of the calculated cash flow for a case when the cash flow is not used for investment with an investment amount defined by a user through the input unit, identifying as an investable term a term when an amount of the cash flow exceeds the investment amount, calculating fund in hand and an investment effect when the fund in hand is invested in a user-specified investment target for the investable term, and identifying an investment period causing a maximum investment effect and an investment amount therefor; and
displaying the cash flow movement and pieces of information of the investment effect on a display unit.
